(19) United States
(12) Patent Application Publication
(10) Pub. No.: US 2013/0179116 A1
(43) Pub. Date: Jul. 11, 2013

(54) SPATIAL AND TEMPORAL VECTOR ANALYSIS IN WEARABLE DEVICES USING SENSOR DATA

(71) Applicants: Hosain Sadequr Rahman, San Francisco, CA (US); Michael Edward Smith Luna, San Jose, CA (US); Travis Austin Bogard, San Francisco, CA (US); Max Everett Utter, II, San Francisco, CA (US); Richard Lee Drysdale, San Francisco, CA (US); Scott Fullam, Palo Alto, CA (US); Jeremiah Robison, San Francisco, CA (US); Thomas Alan Donaldson, London (GB)

(72) Inventors: Hosain Sadequr Rahman, San Francisco, CA (US); Michael Edward Smith Luna, San Jose, CA (US); Travis Austin Bogard, San Francisco, CA (US); Max Everett Utter, II, San Francisco, CA (US); Richard Lee Drysdale, San Francisco, CA (US); Scott Fullam, Palo Alto, CA (US); Jeremiah Robison, San Francisco, CA (US); Thomas Alan Donaldson, London (GB)

(73) Assignee: AliphCom, San Francisco, CA (US)

(21) Appl. No.: 13/492,776

(22) Filed: Jun. 8, 2012

Related U.S. Application Data
(63) Continuation-in-part of application No. 13/158,372, filed on Jun. 10, 2011.
Application No. 13/158,372 is a continuation-in-part of application No. 13/180,320, filed on Jul. 11, 2011.
Application No. 13/180,320 is a continuation-in-part of application No. 13/158,416, filed on Jun. 11, 2011.
Application No. 13/158,416 is a continuation-in-part of application No. 13/158,372, filed on Jun. 10, 2011.
Application No. 13/158,372 is a continuation-in-part of application No. 13/180,000, filed on Jul. 11, 2011.
Application No. 13/180,000 is a continuation-in-part of application No. 13/158,372, filed on Jun. 10, 2011.
Application No. 13/158,372 is a continuation-in-part of application No. 13/158,416, filed on Jun. 11, 2011.
Application No. 13/158,416 is a continuation-in-part of application No. 13/158,372, filed on Jun. 10, 2011.

(51) Int. Cl. A41D 1/00; G01B 21/16

(52) U.S. Cl. CPC A41D 1/002; G01B 21/16
USPC 702/150

(57) ABSTRACT

Spatial and temporal vector analysis in wearable devices using sensor data are described, including evaluating a motion to determine motion signals, the motion being evaluated using data provided by one or more sensors in data communication with a wearable device, isolating motion signals into one or more motion sub-signals, determining a spatial vector and a temporal vector associated with each of the one or more motion sub-signals, and transforming the spatial vector and the temporal vector into a data structure to be used by an application configured to analyze the data structure and to generate content associated with the motion.

### CROSS-REFERENCE TO RELATED APPLICATIONS

This application is a continuation-in-part of U.S. patent application Ser. No. 13/158,372, filed Jun. 10, 2011; this application also is a continuation-in-part of U.S. patent application Ser. No. 13/180,320, filed Jul. 11, 2011, which is a continuation-in-part of prior U.S. patent application Ser. No. 13/158,416, filed Jun. 11, 2011, which is a continuation-in-part of U.S. patent application Ser. No. 13/158,372, filed Jun. 10, 2011, and which claims the benefit of U.S. Provisional Patent Application No. 61/495,995, filed Jun. 11, 2011, U.S. Provisional Patent Application No. 61/495,994, U.S. Provisional Patent Application No. 61/495,997, filed Jun. 11, 2011, and U.S. Provisional Patent Application No. 611,495,996, filed Jun. 11, 2011; this application also is a continuation-in-part of U.S. patent application Ser. No. 13/180,000, which is a continuation-in-part of prior U.S. patent application Ser. No. 13/158,372, filed Jun. 10, 2011, and a continuation-in-part of prior U.S. patent application Ser. No. 13/158,416, filed Jun. 11, 2011, which is a continuation-in-part of U.S. patent application Ser. No. 13/158,372, filed Jun. 10, 2011, and which claims the benefit of U.S. Provisional Patent Application No. 61/495,995, filed Jun. 11, 2011, U.S. Provisional Patent Application No. 61/495,994, U.S. Provisional Patent Application No. 61/495,997, filed Jun. 11, 2011, and U.S. Provisional Patent Application No. 61/,495,996, filed Jun. 11, 2011; and this application claims the benefit of U.S. Provisional Patent Application No. 61/495,997, filed Jun. 11, 2011, U.S. Provisional Patent Application No. 61/495,995, filed Jun. 11, 2011, U.S. Provisional Patent Application No. 61/495,994, filed Jun. 11, 2011, U.S. Provisional Patent Application No. 61/495,996, filed Jun. 11, 2011, U.S. Provisional Patent Application No. 61/572,206, filed Jul. 12, 2011, and U.S. Provisional Patent Application No. 61/572.204, filed Jul. 12, 2011, all of which is hereby incorporated by reference in its entirety for all purposes.

### FIELD

The present invention relates generally to electrical and electronic hardware, computer software, wired and wireless network communications, and computing devices. More specifically, techniques for spatial and temporal vector analysis in wearable devices using sensor data are described.

### BACKGROUND

With the advent of greater computing capabilities in smaller personal and/or portable form factors and an increasing number of applications (i.e., computer and Internet software or programs) for different uses, consumers (i.e., users) have access to large amounts of personal data. Information and data are often readily available, but poorly captured using conventional data capture devices. Conventional devices typically lack capabilities that can capture, analyze, communicate, or use data in a contextually-meaningful, comprehensive, and efficient manner. Further, conventional solutions are often limited to specific individual purposes or uses, demanding that users invest in multiple devices in order to perform different activities (e.g., a sports watch for tracking time and distance, a GPS receiver for monitoring a hike or run, a cyclometer for gathering cycling data, and others). Although a wide range of data and information is available, conventional devices and applications fail to provide effective solutions that comprehensively capture data for a given user across numerous disparate activities.

Some conventional solutions combine a small number of discrete functions. Functionality for data capture, processing, storage, or communication in conventional devices such as a watch or timer with a heart rate monitor or global positioning system (“GPS”) receiver are available conventionally, but are expensive to manufacture and purchase. Other conventional solutions for combining personal data capture facilities often present numerous design and manufacturing problems such as size restrictions, specialized materials requirements, lowered tolerances for defects such as pits or holes in coverings for water-resistant or waterproof devices, unreliability, higher failure rates, increased manufacturing time, and expense. Further, processing capabilities such as complex software for increasing demands for creative and customized software that can analyze and present sensory data and smaller packaging has led to significantly increased costs and processing challenges. Further, complex software or processing capabilities typically requires significant power availability and results in high power, low life uses of expensive devices. Subsequently, conventional devices such as fitness watches, heart rate monitors, GPS-enabled fitness monitors, health monitors (e.g., diabetic blood sugar testing units), digital voice recorders, pedometers, altimeters, and other conventional personal data capture devices are generally manufactured for conditions that occur in a single or small groupings of activities.

Thus, what is needed is a solution for improving the capabilities of data capture devices without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary data-capable strapband system;

FIG. 2A illustrates an exemplary wearable device and platform for sensory input;

FIG. 2B illustrates an alternative exemplary wearable device and platform for sensory input;

FIG. 3 illustrates sensors for use with an exemplary data-capable strapband;

FIG. 4 illustrates an application architecture for an exemplary data-capable strapband;

FIG. 5A illustrates representative data types for use with an exemplary data-capable strapband;

FIG. 5B illustrates representative data types for use with an exemplary data-capable strapband in fitness-related activities;

FIG. 5C illustrates representative data types for use with an exemplary data-capable strapband in sleep management activities;

FIG. 5D illustrates representative data types for use with an exemplary data-capable strapband in medical-related activities;

FIG. 5E illustrates representative data types for use with an exemplary data-capable strapband in social media/networking-related activities;

FIG. 6 illustrates an exemplary recommendation system;

FIG. 7 illustrates an exemplary system for feature extraction from body-worn accelerometers;

FIG. 8 illustrates an exemplary determinative process for wearable devices;

FIG. 9 illustrates another exemplary determinative process for wearable devices; and

FIG. 10 illustrates an exemplary computer system suitable for use with a data-capable strapband.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

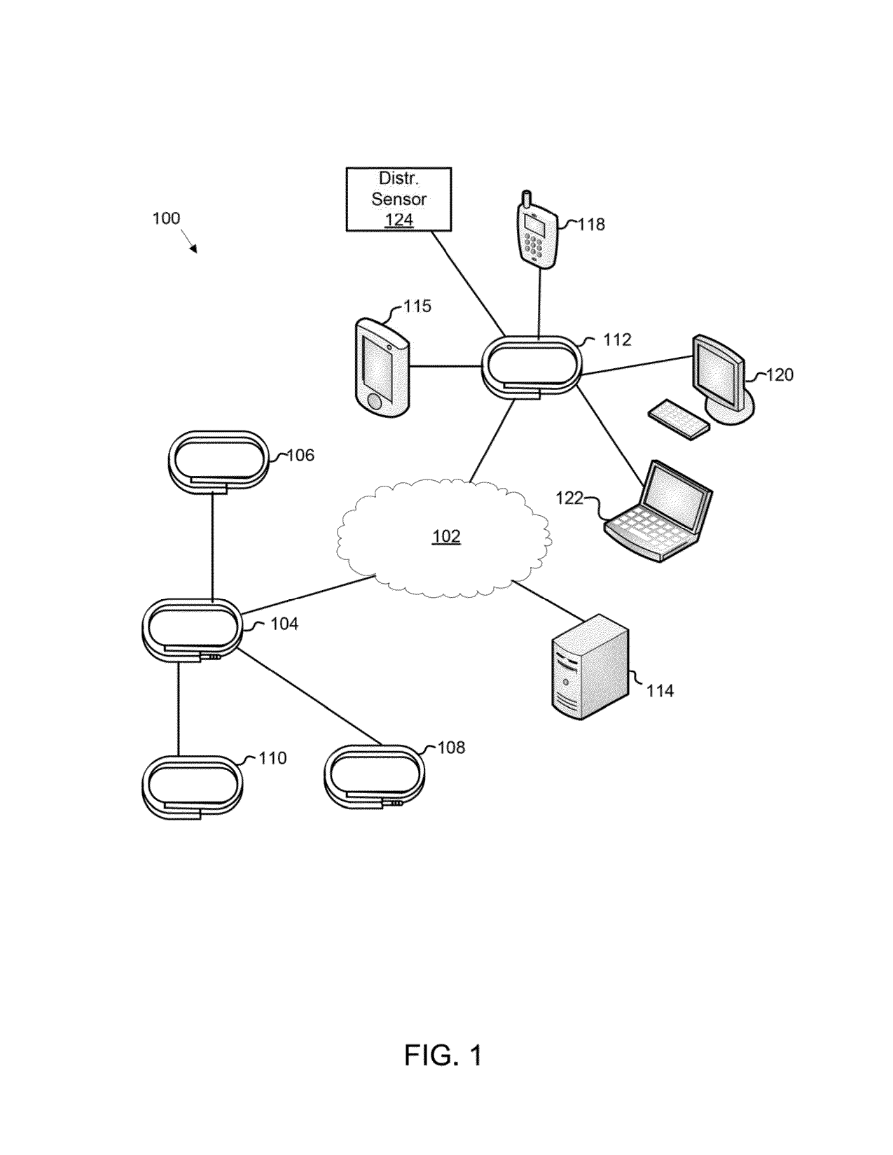

FIG. 1 illustrates an exemplary data-capable strapband system. Here, system 100 includes network 102, strapbands (hereafter “bands”) 104-112, server 114, mobile computing device 115, mobile communications device 118, computer 120, laptop 122, and distributed sensor 124. Although used interchangeably, “strapband” and “band” may be used to refer to the same or substantially similar data-capable device that may be worn as a strap or band around an arm, leg, ankle, or other bodily appendage or feature. In other examples, bands 104-112 may be attached directly or indirectly to other items, organic or inorganic, animate, or static. In still other examples, bands 104-112 may be used differently.

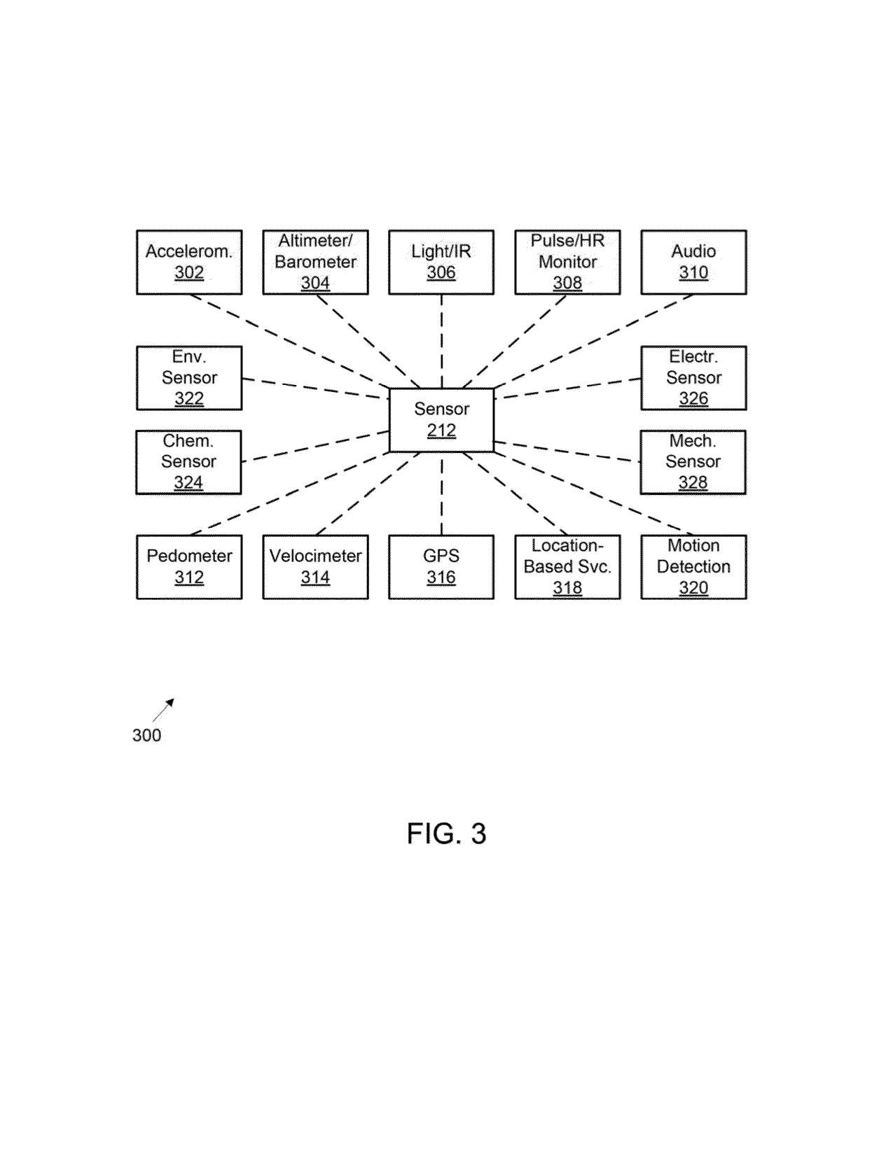

As described above, bands 104-112 may be implemented as wearable personal data or data capture devices (e.g., data-capable devices) that are worn by a user around a wrist, ankle, arm, ear, or other appendage, or attached to the body or affixed to clothing. One or more facilities, sensing elements, or sensors, both active and passive, may be implemented as part of bands 104-112 in order to capture various types of data from different sources. Temperature, environmental, temporal, motion, electronic, electrical, chemical, or other types of sensors (including those described below in connection with FIG. 3) may be used in order to gather varying amounts of data, which may be configurable by a user, locally (e.g., using user interface facilities such as buttons, switches, motion-activated/detected command structures (e.g., accelerometer-gathered data from user-initiated motion of bands 104-112), and others) or remotely (e.g., entering rules or parameters in a website or graphical user interface (“GUI”) that may be used to modify control systems or signals in firmware, circuitry, hardware, and software implemented (i.e., installed) on bands 104-112). In some examples, a user interface may be any type of human-computing interface (e.g., graphical, visual, audible, haptic, or any other type of interface that communicates information to a user (i.e., wearer of bands 104-112) using, for example, noise, light, vibration, or other sources of energy and data generation (e.g., pulsing vibrations to represent various types of signals or meanings, blinking lights, and the like, without limitation)) implemented locally (i.e., on or coupled to one or more of bands 104-112) or remotely (i.e., on a device other than bands 104-112). In other examples, a wearable device such as bands 104-112 may also be implemented as a user interface configured to receive and provide input to or from a user (i.e., wearer). Bands 104-112 may also be implemented as data-capable devices that are configured for data communication using various types of communications infrastructure and media, as described in greater detail below. Bands 104-112 may also be wearable, personal, non-intrusive, lightweight devices that are configured to gather large amounts of personally relevant data that can be used to improve user health, fitness levels, medical conditions, athletic performance, sleeping physiology, and physiological conditions, or used as a sensory-based user interface (“UI”) to signal social-related notifications specifying the state of the user through vibration, heat, lights or other sensory based notifications. For example, a social-related notification signal indicating a user is on-line can be transmitted to a recipient, who in turn, receives the notification as, for instance, a vibration.

Using data gathered by bands 104-112, applications may be used to perform various analyses and evaluations that can generate information as to a person's physical (e.g., healthy, sick, weakened, or other states, or activity level), emotional, or mental state (e.g., an elevated body temperature or heart rate may indicate stress, a lowered heart rate and skin temperature, or reduced movement (excessive sleeping), may indicate physiological depression caused by exertion or other factors, chemical data gathered from evaluating outgassing from the skin's surface may be analyzed to determine whether a person's diet is balanced or if various nutrients are lacking, salinity detectors may be evaluated to determine if high, lower, or proper blood sugar levels are present for diabetes management, and others). Generally, bands 104-112 may be configured to gather from sensors locally and remotely.

As an example, band 104 may capture (i.e., record, store, communicate (i.e., send or receive), process, or the like) data from various sources (i.e., sensors that are organic (i.e., installed, integrated, or otherwise implemented with band 104) or distributed (e.g., microphones on mobile computing device 115, mobile communications device 118, computer 120, laptop 122, distributed sensor 124, global positioning system (“GPS”) satellites (in low, mid, or high earth orbit), or others, without limitation)) and exchange data with one or more of bands 106-112, server 114, mobile computing device 115, mobile communications device 118, computer 120, laptop 122, and distributed sensor 124. As shown here, a local sensor may be one that is incorporated, integrated, or otherwise implemented with bands 104-112. A remote or distributed sensor (e.g., mobile computing device 115, mobile communications device 118, computer 120, laptop 122, or, generally, distributed sensor 124) may be sensors that can be accessed, controlled, or otherwise used by bands 104-112. For example, band 112 may be configured to control devices that are also controlled by a given user (e.g., mobile computing device 115, mobile communications device 118, computer 120, laptop 122, and distributed sensor 124). For example, a microphone in mobile communications device 118 may be used to detect, for example, ambient audio data that is used to help identify a person's location, or an ear clip (e.g., a headset as described below) affixed to an ear may be used to record pulse or blood oxygen saturation levels. Additionally, a sensor implemented with a screen on mobile computing device 115 may be used to read a user's temperature or obtain a biometric signature while a user is interacting with data. A further example may include using data that is observed on computer 120 or laptop 122 that provides information as to a user's online behavior and the type of content that she is viewing, which may be used by bands 104-112. Regardless of the type or location of sensor used, data may be transferred to bands 104-112 by using, for example, an analog audio jack, digital adapter (e.g., USB, mini-USB), or other, without limitation, plug, or other type of connector that may be used to physically couple bands 104-112 to another device or system for transferring data and, in some examples, to provide power to recharge a battery (not shown). Alternatively, a wireless data communication interface or facility (e.g., a wireless radio that is configured to communicate data from bands 104-112 using one or more data communication protocols (e.g., IEEE 802.11a/b/g/n (WiFi), WiMax, ANT™, ZigBee®, Bluetooth®, Near Field Communications (“NFC”), and others)) may be used to receive or transfer data. Further, bands 104-112 may be configured to analyze, evaluate, modify, or otherwise use data gathered, either directly or indirectly.

In some examples, bands 104-112 may be configured to share data with each other or with an intermediary facility, such as a database, website, web service, or the like, which may be implemented by server 114. In some embodiments, server 114 can be operated by a third party providing, for example, social media-related services. Bands 104-112 and other related devices may exchange data with each other directly, or bands 104-112 may exchange data via a third party server, such as a third party like Facebook®, to provide social-media related services. Examples of third party servers include servers for social networking services, including, but not limited to, services such as Facebook®, Yahoo! IM™, GTalk™, MSN Messenger™, Twitter® and other private or public social networks. The exchanged data may include personal 20 physiological data and data derived from sensory-based user interfaces (“UI”). Server 114, in some examples, may be implemented using one or more processor-based computing devices or networks, including computing clouds, storage area networks (“SAN”), or the like. As shown, bands 104-112 may be used as a personal data or area network (e.g., “PDN” or “PAN”) in which data relevant to a given user or band (e.g., one or more of bands 104-112) may be shared. As shown here, bands 104 and 112 may be configured to exchange data with each other over network 102 or indirectly using server 114. Users of bands 104 and 112 may direct a web browser hosted on a computer (e.g., computer 120, laptop 122, or the like) in order to access, view, modify, or perform other operations with data captured by bands 104 and 112. For example, two runners using bands 104 and 112 may be geographically remote (e.g., users are not geographically in close proximity locally such that bands being used by each user are in direct data communication), but wish to share data regarding their race times (pre, post, or in-race), personal records (i.e., “PR”), target split times, results, performance characteristics (e.g., target heart rate, target VO₂ max, and others), and other information. If both runners (i.e., bands 104 and 112) are engaged in a race on the same day, data can be gathered for comparative analysis and other uses. Further, data can be shared in substantially real-time (taking into account any latencies incurred by data transfer rates, network topologies, or other data network factors) as well as uploaded after a given activity or event has been performed. In other words, data can be captured by the user as it is worn and configured to transfer data using, for example, a wireless network connection (e.g., a wireless network interface card, wireless local area network (“LAN”) card, cell phone, or the like. Data may also be shared in a temporally asynchronous manner in which a wired data connection (e.g., an analog audio plug (and associated software or firmware) configured to transfer digitally encoded data to encoded audio data that may be transferred between bands 104-112 and a plug configured to receive, encode/decode, and process data exchanged) may be used to transfer data from one or more bands 104-112 to various destinations (e.g., another of bands 104-112, server 114, mobile computing device 115, mobile communications device 118, computer 120, laptop 122, and distributed sensor 124). Bands 104-112 may be implemented with various types of wired and/or wireless communication facilities and are not intended to be limited to any specific technology. For example, data may be transferred from bands 104-112 using an analog audio plug (e.g., TRRS, TRS, or others). In other examples, wireless communication facilities using various types of data communication protocols (e.g., WiFi, Bluetooth®, ZigBeee®, ANT™, and others) may be implemented as part of bands 104-112, which may include circuitry, firmware, hardware, radios, antennas, processors, microprocessors, memories, or other electrical, electronic, mechanical, or physical elements configured to enable data communication capabilities of various types and characteristics.

As data-capable devices, bands 104-112 may be configured to collect data from a wide range of sources, including onboard (not shown) and distributed sensors (e.g., server 114, mobile computing device 115, mobile communications device 118, computer 120, laptop 122, and distributed sensor 124) or other bands. Some or all data captured may be personal, sensitive, or confidential and various techniques for providing secure storage and access may be implemented. For example, various types of security protocols and algorithms may be used to encode data stored or accessed by bands 104-112. Examples of security protocols and algorithms include authentication, encryption, encoding, private and public key infrastructure, passwords, checksums, hash codes and hash functions (e.g., SHA, SHA-1, MD-5, and the like), or others may be used to prevent undesired access to data captured by bands 104-112. In other examples, data security for bands 104-112 may be implemented differently.

Bands 104-112 may be used as personal wearable, data capture devices that, when worn, are configured to identify a specific, individual user. By evaluating captured data such as motion data from an accelerometer, biometric data such as heart rate, skin galvanic response, and other biometric data, and using analysis techniques, both long and short-term (e.g., software packages or modules of any type, without limitation), a user may have a unique pattern of behavior or motion and/or biometric responses that can be used as a signature for identification. For example, bands 104-112 may gather data regarding an individual person's gait or other unique biometric, physiological or behavioral characteristics. Using, for example, distributed sensor 124, a biometric signature (e.g., fingerprint, retinal or iris vascular pattern, or others) may be gathered and transmitted to bands 104-112 that, when combined with other data, determines that a given user has been properly identified and, as such, authenticated. When bands 104-112 are worn, a user may be identified and authenticated to enable a variety of other functions such as accessing or modifying data, enabling wired or wireless data transmission facilities (i.e., allowing the transfer of data from bands 104-112), modifying functionality or functions of bands 104-112, authenticating financial transactions using stored data and information (e.g., credit card, PIN, card security numbers, and the like), running applications that allow for various operations to be performed (e.g., controlling physical security and access by transmitting a security code to a reader that, when authenticated, unlocks a door by turning off current to an electromagnetic lock, and others), and others. Different functions and operations beyond those described may be performed using bands 104-112, which can act as secure, personal, wearable, data-capable devices. The number, type, function, configuration, specifications, structure, or other features of system 100 and the above-described elements may be varied and are not limited to the examples provided.

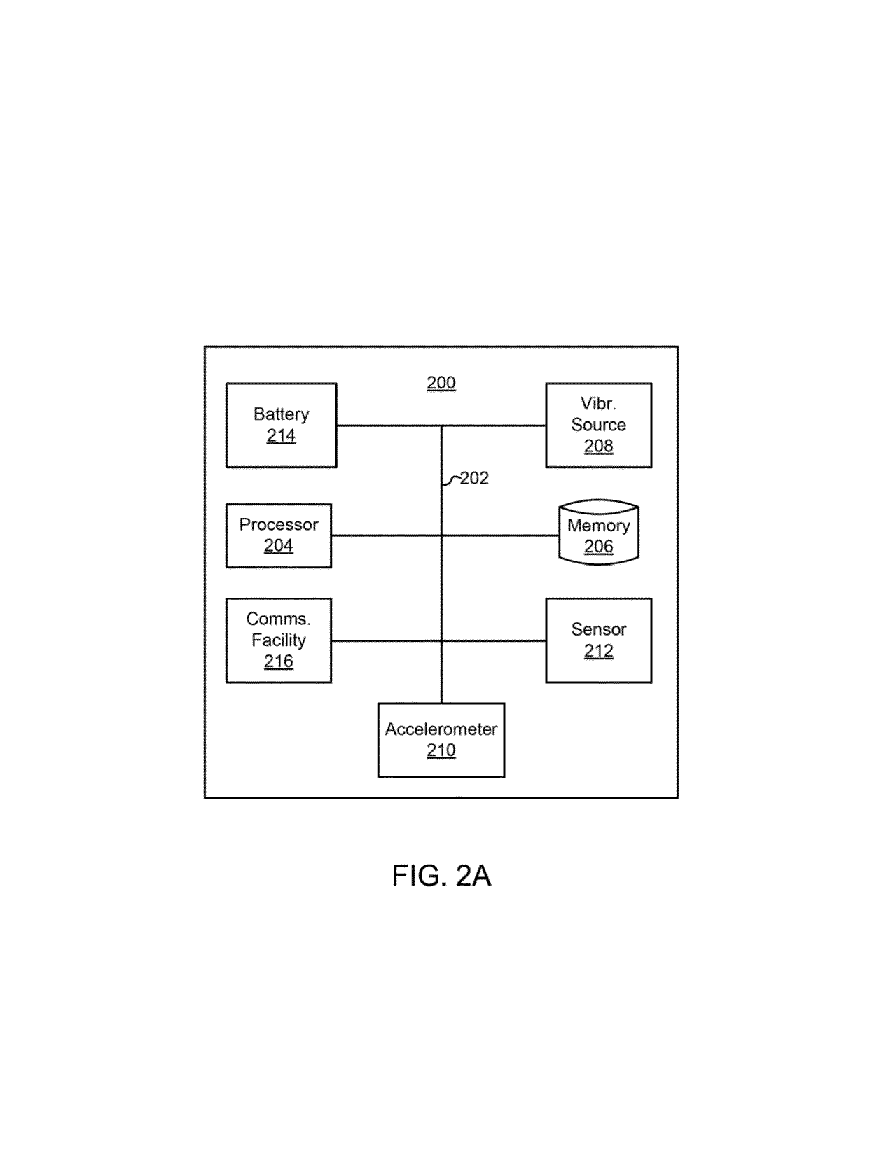

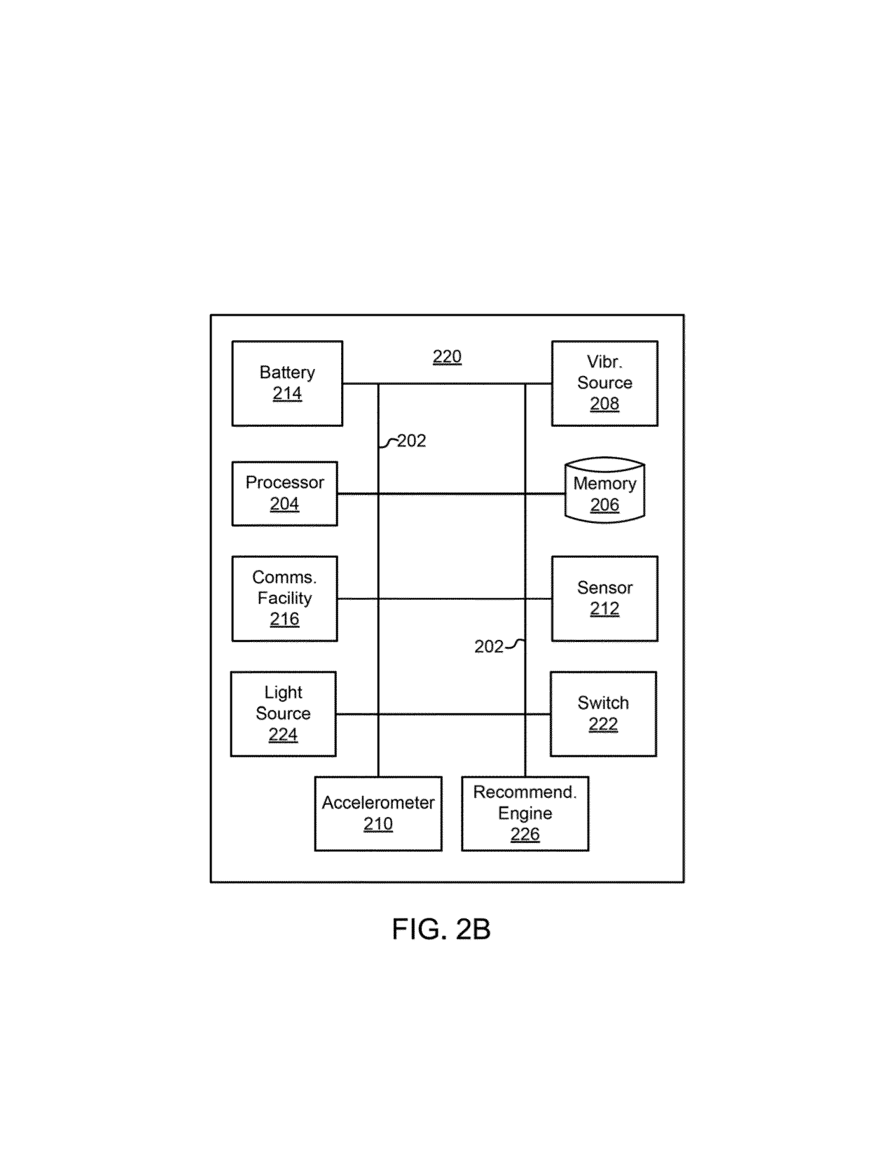

FIG. 2A illustrates an exemplary wearable device and platform for sensory input. Here, band (i.e., wearable device) 200 includes bus 202, processor 204, memory 206, vibration source 208, accelerometer 210, sensor 212, battery 214, and communications facility 216. In some examples, the quantity, type, function, structure, and configuration of band 200 and the elements (e.g., bus 202, processor 204, memory 206, vibration source 208, accelerometer 210, sensor 212, battery 214, and communications facility 216) shown may be varied and are not limited to the examples provided. As shown, processor 204 may be implemented as logic to provide control functions and signals to memory 206, vibration source 208, accelerometer 210, sensor 212, battery 214, and communications facility 216. Processor 204 may be implemented using any type of processor or microprocessor suitable for packaging within bands 104-112 (FIG. 1). Various types of microprocessors may be used to provide data processing capabilities for band 200 and are not limited to any specific type or capability. For example, a MSP430F5528-type microprocessor manufactured by Texas Instruments of Dallas, Tex. may be configured for data communication using audio tones and enabling the use of an audio plug-and-jack system (e.g., TRRS, TRS, or others) for transferring data captured by band 200. Further, different processors may be desired if other functionality (e.g., the type and number of sensors (e.g., sensor 212)) are varied. Data processed by processor 204 may be stored using, for example, memory 206.

In some examples, memory 206 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Memory 206 may also be implemented using one or more partitions that are configured for multiple types of data storage technologies to allow for non-modifiable (i.e., by a user) software to be installed (e.g., firmware installed on ROM) while also providing for storage of captured data and applications using, for example, RAM. Once captured and/or stored in memory 206, data may be subjected to various operations performed by other elements of band 200.

Vibration source 208, in some examples, may be implemented as a motor or other mechanical structure that functions to provide vibratory energy that is communicated through band 200. As an example, an application stored on memory 206 may be configured to monitor a clock signal from processor 204 in order to provide timekeeping functions to band 200. If an alarm is set for a desired time, vibration source 208 may be used to vibrate when the desired time occurs. As another example, vibration source 208 may be coupled to a framework (not shown) or other structure that is used to translate or communicate vibratory energy throughout the physical structure of band 200. In other examples, vibration source 208 may be implemented differently.

Power may be stored in battery 214, which may be implemented as a battery, battery module, power management module, or the like. Power may also be gathered from local power sources such as solar panels, thermo-electric generators, and kinetic energy generators, among others that are alternatives power sources to external power for a battery. These additional sources can either power the system directly or can charge a battery, which, in turn, is used to power the system (e.g., of a strapband). In other words, battery 214 may include a rechargeable, expendable, replaceable, or other type of battery, but also circuitry, hardware, or software that may be used in connection with in lieu of processor 204 in order to provide power management, charge/recharging, sleep, or other functions. Further, battery 214 may be implemented using various types of battery technologies, including Lithium Ion (“LI”), Nickel Metal Hydride (“NiMH”), or others, without limitation. Power drawn as electrical current may be distributed from battery via bus 202, the latter of which may be implemented as deposited or formed circuitry or using other forms of circuits or cabling, including flexible circuitry. Electrical current distributed from battery 204 and managed by processor 204 may be used by one or more of memory 206, vibration source 208, accelerometer 210, sensor 212, or communications facility 216.

As shown, various sensors may be used as input sources for data captured by band 200. For example, accelerometer 210 may be used to detect a motion or other condition and convert it to data as measured across one, two, or three axes of motion. In addition to accelerometer 210, other sensors (i.e., sensor 212) may be implemented to provide temperature, environmental, physical, chemical, electrical, or other types of sensory inputs. As presented here, sensor 212 may include one or multiple sensors and is not intended to be limiting as to the quantity or type of sensor implemented. Sensory input captured by band 200 using accelerometer 210 and sensor 212 or data requested from another source (i.e., outside of band 200) may also be converted to data and exchanged, transferred, or otherwise communicated using communications facility 216. As used herein, “facility” refers to any, some, or all of the features and structures that are used to implement a given set of functions. For example, communications facility 216 may include a wireless radio, control circuit or logic, antenna, transceiver, receiver, transmitter, resistors, diodes, transistors, or other elements that are used to transmit and receive data from band 200. In some examples, communications facility 216 may be implemented to provide a “wired” data communication capability such as an analog or digital attachment, plug, jack, or the like to allow for data to be transferred. In other examples, communications facility 216 may be implemented to provide a wireless data communication capability to transmit digitally encoded data across one or more frequencies using various types of data communication protocols, without limitation. In still other examples, band 200 and the above-described elements may be varied in function, structure, configuration, or implementation and are not limited to those shown and described.

FIG. 2B illustrates an alternative exemplary wearable device and platform for sensory input. Here, band (i.e., wearable device) 220 includes bus 202, processor 204, memory 206, vibration source 208, accelerometer 210, sensor 212, battery 214, communications facility 216, switch 222, light source 224, and recommendation engine 226. Like-numbered and named elements may be implemented similarly in function and structure to those described in prior examples. Further, the quantity, type, function, structure, and configuration of band 200 and the elements (e.g., bus 202, processor 204, memory 206, vibration source 208, accelerometer 210, sensor 212, battery 214, communications facility 216, switch 222, light source 224, and recommendation engine 226) shown may be varied and are not limited to the examples provided.

In some examples, band 200 may be implemented as an alternative structure to band 200 (FIG. 2A) described above. For example, sensor 212 may be configured to sense, detect, gather, or otherwise receive input (i.e., sensed physical, chemical, biological, physiological, or psychological quantities) that, once received, may be converted into data and transferred to processor 204 using bus 202. As an example, temperature, heart rate, respiration rate, galvanic skin response (i.e., skin conductance response), muscle stiffness/fatigue, and other types of conditions or parameters may be measured using sensor 212, which may be implemented using one or multiple sensors. Further, sensor 212 is generally coupled (directly or indirectly) to band 220. As used herein, “coupled” may refer to a sensor being locally implemented on band 220 or remotely on, for example, another device that is in data communication with it.

Sensor 212 may be configured, in some examples, to sense various types of environmental (e.g., ambient air temperature, barometric pressure, location (e.g., using GPS or other satellite constellations for calculating Cartesian, polar, or other coordinates on the earth's surface, micro-cell network triangulation, or others), physical, physiological, psychological, or activity-based conditions in order to determine a state of a user of wearable device 220 (i.e., band 220). In other examples, applications or firmware may be downloaded that, when installed, may be configured to change sensor 212 in terms of function. Sensory input to sensor 212 may be used for various purposes such as measuring caloric burn rate, providing active (e.g., generating an alert such as vibration, audible, or visual indicator) or inactive (e.g., providing information, content, promotions, advertisements, or the like on a website, mobile website, or other location that is accessible using an account that is associated with a user and band 220) feedback, measuring fatigue (e.g., by calculating skin conductance response (hereafter “SCR”) using sensor 212 or accelerometer 210) or other physical states, determining a mood of a user, and others, without limitation. As used herein, feedback may be provided using a mechanism (i.e., feedback mechanism) that is configured to provide an alert or other indicator to a user. Various types of feedback mechanisms may be used, including a vibratory source, motor, light source (e.g., pulsating, blinking, or steady illumination) (e.g., light source 224, which may be implemented as any type of illumination, fluorescing, phosphorescing, or other light-generating mechanism such as light emitting diode (hereafter “LED”), incandescent, fluorescent, or other type of light), audible, audio, visual, haptic, or others, without limitation. Feedback mechanisms may provide sensory output of the types indicated above via band 200 or, in other examples, using other devices that may be in data communication with it. For example, a driver may receive a vibratory alert from vibration source (e.g., motor) 208 when sensor 212 detects skin tautness (using, for example, accelerometer to detect muscle stiffness) that indicates she is falling asleep and, in connection with a GPS-sensed signal, wearable device 220 determines that a vehicle is approaching a divider, intersection, obstacle, or is accelerating/decelerating rapidly, and the like. Further, an audible indicator may be generated and sent to an ear-worn communication device such as a Bluetooth® (or other data communication protocol, near or far field) headset. Other types of devices that have a data connection with wearable device 220 may also be used to provide sensory output to a user, such as using a mobile communications or computing device having a graphical user interface to display data or information associated with sensory input received by sensor 212.

In some examples, sensory output may be an audible tone, visual indication, vibration, or other indicator that can be provided by another device that is in data communication with band 220. In other examples, sensory output may be a media file such as a song that is played when sensor 212 detects a given parameter. For example, if a user is running and sensor 212 detects a heart rate that is lower than the recorded heart rate as measured against 65 previous runs, processor 204 may be configured to generate a control signal to an audio device that begins playing an upbeat or high tempo song to the user in order to increase her heart rate and activity-based performance. As another example, sensor 212 and/or accelerometer 210 may sense various inputs that can be measured against a calculated “lifeline” (e.g., LIFELINE™) that is an abstract representation of a user's health or wellness. If sensory input to sensor 212 (or accelerometer 210 or any other sensor implemented with band 220) is received, it may be compared to the user's lifeline or abstract representation (hereafter “representation”) in order to determine whether feedback, if any, should be provided in order to modify the user's behavior. A user may input a range of tolerance (i.e., a range within which an alert is not generated) or processor 204 may determine a range of tolerance to be stored in memory 206 with regard to various sensory input. For example, if sensor 212 is configured to measure internal bodily temperature, a user may set a 0.1 degree Fahrenheit range of tolerance to allow her body temperature to fluctuate between 98.5 and 98.7 degrees Fahrenheit before an alert is generated (e.g., to avoid heat stress, heat exhaustion, heat stroke, or the like). Sensor 212 may also be implemented as multiple sensors that are disposed (i.e., positioned) on opposite sides of band 220 such that, when worn on a wrist or other bodily appendage, allows for the measurement of skin conductivity in order to determine skin conductance response. Skin conductivity may be used to measure various types of parameters and conditions such as cognitive effort, arousal, lying, stress, physical fatigue due to poor sleep quality, emotional responses to various stimuli, and others.

Activity-based feedback may be given along with state-based feedback. In some examples, band 220 may be configured to provide feedback to a user in order to help him achieve a desired level of fitness, athletic performance, health, or wellness. In addition to feedback, band 220 may also be configured to provide indicators of use to a wearer during, before, or after a given activity or state. Feedback may also be generated by recommendation engine 226.

In some examples, recommendation engine 226 may be implemented using software, hardware, circuitry, or a combination thereof. Any type of computer programming, formatting, or scripting language may be used to implement recommendation engine and the techniques described. For example, recommendation engine 226 may be configured to generate content associated with a given state or activity as a result of sensory input received by sensor 212 and/or accelerometer and processed by processor 204. As shown, recommendation engine 226 may receive various types of data transformed from sensory input by sensor 212. Requests or calls may be sent to memory 206, which may be implemented as either local or remote storage that includes one or more data storage facilities, such as those described herein. Content to be delivered by recommendation engine 226 may take various forms, including text, graphical, visual, audible, audio, multi-media, applications, algorithms, or other formats that may be delivered using various types of user interfaces, such as those described herein. In some examples, content may be retrieved from “marketplaces” where users may select various types of algorithms, templates, or other collective applications that may be configured for use with band 220. For example, a “marketplace framework” may be used to offer applications, algorithms, programs, or other types of data or information for sell, lease, or free to users of wearable devices. Marketplaces may be implemented using any type of structure that provides for the sale, purchase, lease, or license of content such as that described above. Based on various types of activities or states (e.g., physiological, psychological, or otherwise) models that provide applications that, when installed and executed, enable a user to perform certain functions with feedback from band 200, may also be downloaded from a marketplace. In other examples, marketplaces of various types and purposes may be implemented.

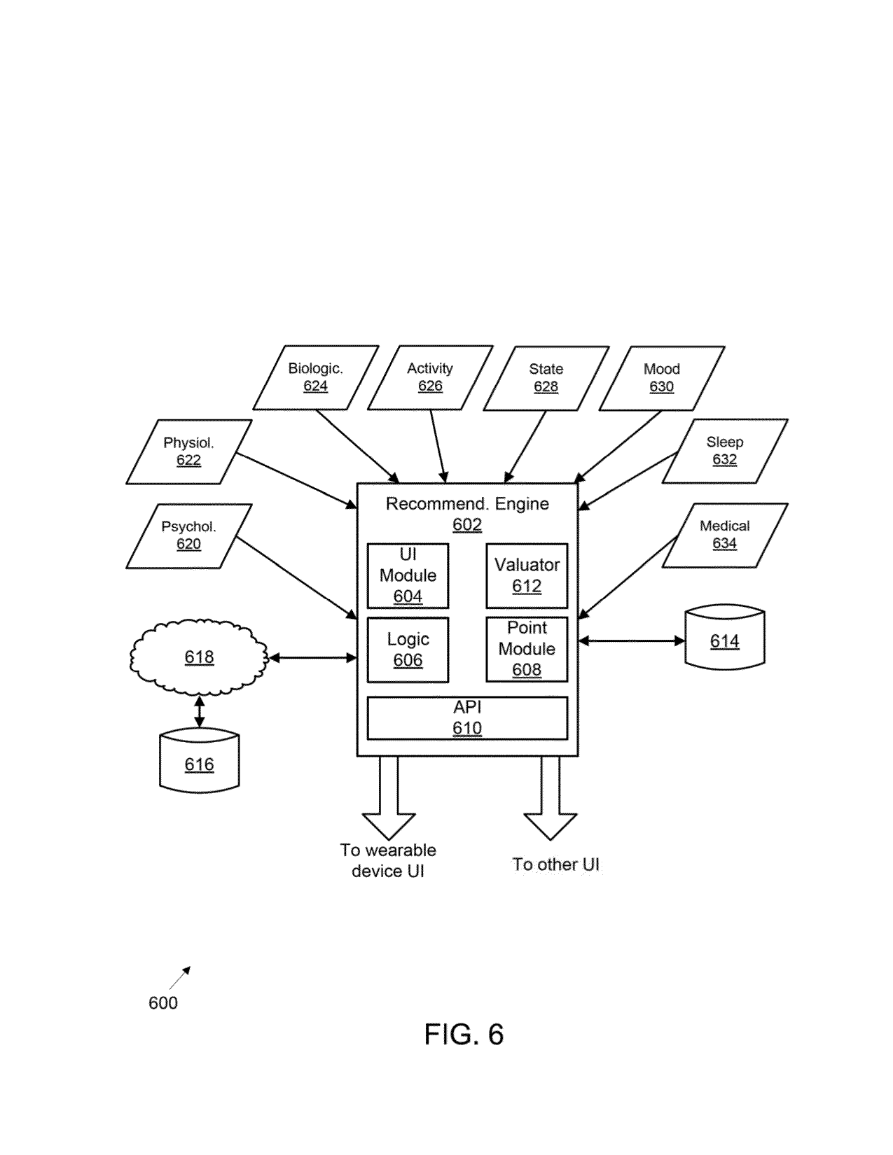

Recommendation engine 226 may also be implemented to evaluate data associated with various types of sensory input in order to determine the type of content to be generated and delivered, either to a wearable device (e.g., band 220) or to another device that may or may not be coupled to, but in data communication (i.e., using various types of data communication protocols and networks) with band 220. Recommendation engine 226 is described in greater detail below in connection with FIG. 6.

Referring back to FIG. 2B and as used herein, various types of indicators (e.g., audible, visual, mechanical, or the like) may also be used in order to provide a sensory user interface. In other words, band 220 may be configured with switch 222 that can be implemented using various types of structures as indicators of device state, function, operation, mode, or other conditions or characteristics. Examples of indicators include “wheel” or rotating structures such as dials or buttons that, when turned to a given position, indicate a particular function, mode, or state of band 220. Other structures may include single or multiple-position switches that, when turned to a given position, are also configured for the user to visually recognize a function, mode, or state of band 220. For example, a 4-position switch or button may indicate “on,” “off,” standby,” “active,” “inactive,” or other mode. A 2-position switch or button may also indicate other modes of operation such as “on” and “off.” As yet another example, a single switch or button may be provided such that, when the switch or button is depressed, band 220 changes mode or function without, alternatively, providing a visual indication. In other examples, different types of buttons, switches, or other user interfaces may be provided and are not limited to the examples shown.

FIG. 3 illustrates sensors for use with an exemplary data-capable strapband. Sensor 212 may be implemented using various types of sensors, some of which are shown. Like-numbered and named elements may describe the same or substantially similar element as those shown in other descriptions. Here, sensor 212 (FIG. 2) may be implemented as accelerometer 302, altimeter/barometer 304, light/infrared (“IR”) sensor 306, pulse/heart rate (“HR”) monitor 308, audio sensor (e.g., microphone, transducer, or others) 310, pedometer 312, velocimeter 314, GPS receiver 316, location-based service sensor (e.g., sensor for determining location within a cellular or micro-cellular network, which may or may not use GPS or other satellite constellations for fixing a position) 318, motion detection sensor 320, environmental sensor 322, chemical sensor 324, electrical sensor 326, or mechanical sensor 328.

As shown, accelerometer 302 may be used to capture data associated with motion detection along 1, 2, or 3-axes of measurement, without limitation to any specific type of specification of sensor. Accelerometer 302 may also be implemented to measure various types of user motion and may be configured based on the type of sensor, firmware, software, hardware, or circuitry used. As another example, altimeter/barometer 304 may be used to measure environment pressure, atmospheric or otherwise, and is not limited to any specification or type of pressure-reading device. In some examples, altimeter/barometer 304 may be an altimeter, a barometer, or a combination thereof. For example, altimeter/barometer 304 may be implemented as an altimeter for measuring above ground level (“AGL”) pressure in band 200, which has been configured for use by naval or military aviators. As another example, altimeter/barometer 304 may be implemented as a barometer for reading atmospheric pressure for marine-based applications. In other examples, altimeter/barometer 304 may be implemented differently.

Other types of sensors that may be used to measure light or photonic conditions include light/IR sensor 306, motion detection sensor 320, and environmental sensor 322, the latter of which may include any type of sensor for capturing data associated with environmental conditions beyond light. Further, motion detection sensor 320 may be configured to detect motion using a variety of techniques and technologies, including, but not limited to comparative or differential light analysis (e.g., comparing foreground and background lighting), sound monitoring, or others. Audio sensor 310 may be implemented using any type of device configured to record or capture sound.

In some examples, pedometer 312 may be implemented using devices to measure various types of data associated with pedestrian-oriented activities such as running or walking. Footstrikes, stride length, stride length or interval, time, and other data may be measured. Velocimeter 314 may be implemented, in some examples, to measure velocity (e.g., speed and directional vectors) without limitation to any particular activity. Further, additional sensors that may be used as sensor 212 include those configured to identify or obtain location-based data. For example, GPS receiver 316 may be used to obtain coordinates of the geographic location of band 200 using, for example, various types of signals transmitted by civilian and/or military satellite constellations in low, medium, or high earth orbit (e.g., “LEO,” “MEO,” or “GEO”). In other examples, differential GPS algorithms may also be implemented with GPS receiver 316, which may be used to generate more precise or accurate coordinates. Still further, location-based services sensor 318 may be implemented to obtain location-based data including, but not limited to location, nearby services or items of interest, and the like. As an example, location-based services sensor 318 may be configured to detect an electronic signal, encoded or otherwise, that provides information regarding a physical locale as band 200 passes. The electronic signal may include, in some examples, encoded data regarding the location and information associated therewith. Electrical sensor 326 and mechanical sensor 328 may be configured to include other types (e.g., haptic, kinetic, piezoelectric, piezomechanical, pressure, touch, thermal, and others) of sensors for data input to band 200, without limitation. Other types of sensors apart from those shown may also be used, including magnetic flux sensors such as solid-state compasses and the like. The sensors can also include gyroscopic sensors. While the present illustration provides numerous examples of types of sensors that may be used with band 200 (FIG. 2), others not shown or described may be implemented with or as a substitute for any sensor shown or described.

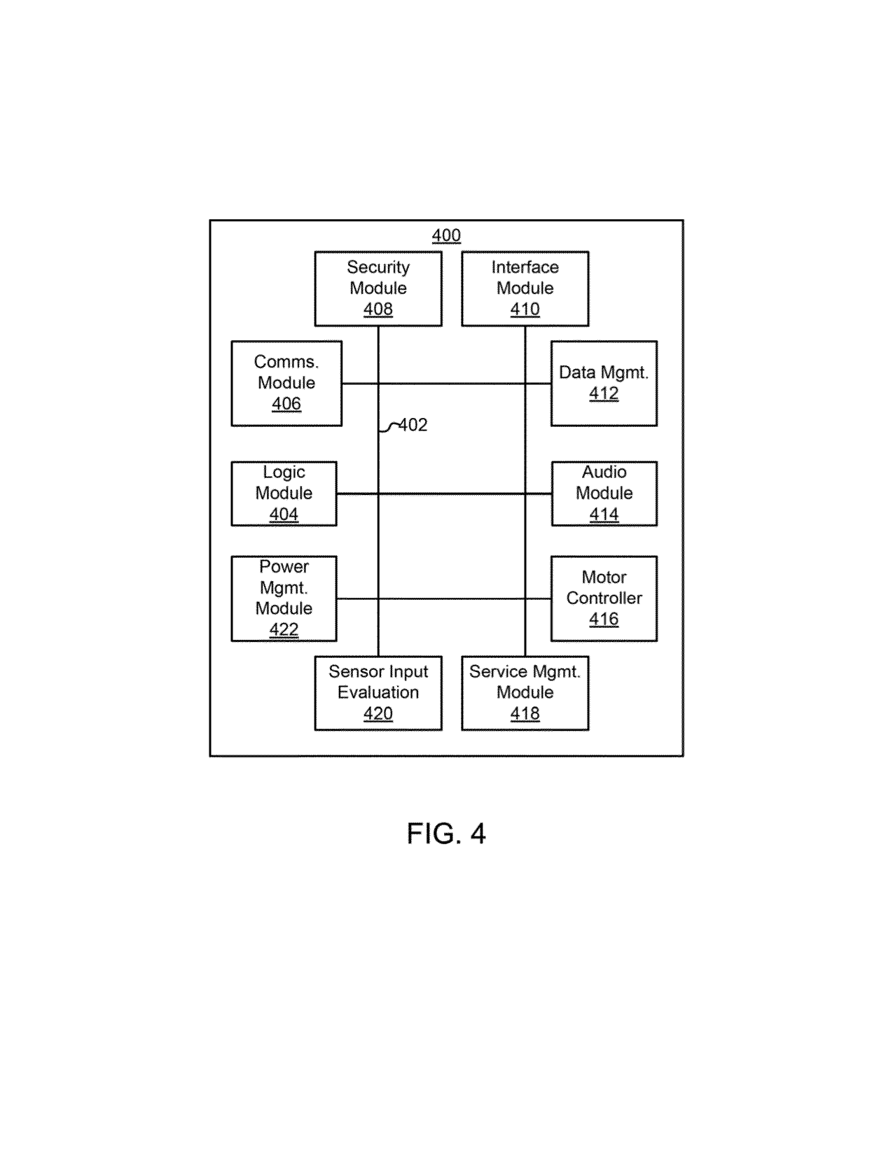

FIG. 4 illustrates an application architecture for an exemplary data-capable strapband. Here, application architecture 400 includes bus 402, logic module 404, communications module 406, security module 408, interface module 410, data management 412, audio module 414, motor controller 416, service management module 418, sensor input evaluation module 420, and power management module 422. In some examples, application architecture 400 and the above-listed elements (e.g., bus 402, logic module 404, communications module 406, security module 408, interface module 410, data management 412, audio module 414, motor controller 416, service management module 418, sensor input evaluation module 420, and power management module 422) may be implemented as software using various computer programming and formatting languages such as Java, C++, C, and others. As shown here, logic module 404 may be firmware or application software that is installed in memory 206 (FIG. 2) and executed by processor 204 (FIG. 2). Included with logic module 404 may be program instructions or code (e.g., source, object, binary executables, or others) that, when initiated, called, or instantiated, perform various functions.

For example, logic module 404 may be configured to send control signals to communications module 406 in order to transfer, transmit, or receive data stored in memory 206, the latter of which may be managed by a database management system (“DBMS”) or utility in data management module 412. As another example, security module 408 may be controlled by logic module 404 to provide encoding, decoding, encryption, authentication, or other functions to band 200 (FIG. 2). Alternatively, security module 408 may also be implemented as an application that, using data captured from various sensors and stored in memory 206 (and accessed by data management module 412) may be used to provide identification functions that enable band 200 to passively identify a user or wearer of band 200. Still further, various types of security software and applications may be used and are not limited to those shown and described.

Interface module 410, in some examples, may be used to manage user interface controls such as switches, buttons, or other types of controls that enable a user to manage various functions of band 200. For example, a 4-position switch may be turned to a given position that is interpreted by interface module 410 to determine the proper signal or feedback to send to logic module 404 in order to generate a particular result. In other examples, a button (not shown) may be depressed that allows a user to trigger or initiate certain actions by sending another signal to logic module 404. Still further, interface module 410 may be used to interpret data from, for example, accelerometer 210 (FIG. 2) to identify specific movement or motion that initiates or triggers a given response. In other examples, interface module 410 may be used to manage different types of displays (e.g., light-emitting diodes (LEDs), interferometric modulator display (IMOD), electrophoretic ink (E Ink), organic light-emitting diode (OLED), etc.). In other examples, interface module 410 may be implemented differently in function, structure, or configuration and is not limited to those shown and described.

As shown, audio module 414 may be configured to manage encoded or unencoded data gathered from various types of audio sensors. In some examples, audio module 414 may include one or more codecs that are used to encode or decode various types of audio waveforms. For example, analog audio input may be encoded by audio module 414 and, once encoded, sent as a signal or collection of data packets, messages, segments, frames, or the like to logic module 404 for transmission via communications module 406. In other examples, audio module 414 may be implemented differently in function, structure, configuration, or implementation and is not limited to those shown and described. Other elements that may be used by band 200 include motor controller 416, which may be firmware or an application to control a motor or other vibratory energy source (e.g., vibration source 208 (FIG. 2)). Power used for band 200 may be drawn from battery 214 (FIG. 2) and managed by power management module 422, which may be firmware or an application used to manage, with or without user input, how power is consumer, conserved, or otherwise used by band 200 and the above-described elements, including one or more sensors (e.g., sensor 212 (FIG. 2), sensors 302-328 (FIG. 3)). With regard to data captured, sensor input evaluation module 420 may be a software engine or module that is used to evaluate and analyze data received from one or more inputs (e.g., sensors 302-328) to band 200. When received, data may be analyzed by sensor input evaluation module 420, which may include custom or “off-the-shelf” analytics packages that are configured to provide application-specific analysis of data to determine trends, patterns, and other useful information. In other examples, sensor input module 420 may also include firmware or software that enables the generation of various types and formats of reports for presenting data and any analysis performed thereupon.

Another element of application architecture 400 that may be included is service management module 418. In some examples, service management module 418 may be firmware, software, or an application that is configured to manage various aspects and operations associated with executing software-related instructions for band 200. For example, libraries or classes that are used by software or applications on band 200 may be served from an online or networked source. Service management module 418 may be implemented to manage how and when these services are invoked in order to ensure that desired applications are executed properly within application architecture 400. As discrete sets, collections, or groupings of functions, services used by band 200 for various purposes ranging from communications to operating systems to call or document libraries may be managed by service management module 418. Alternatively, service management module 418 may be implemented differently and is not limited to the examples provided herein. Further, application architecture 400 is an example of a software/system/application-level architecture that may be used to implement various software-related aspects of band 200 and may be varied in the quantity, type, configuration, function, structure, or type of programming or formatting languages used, without limitation to any given example.

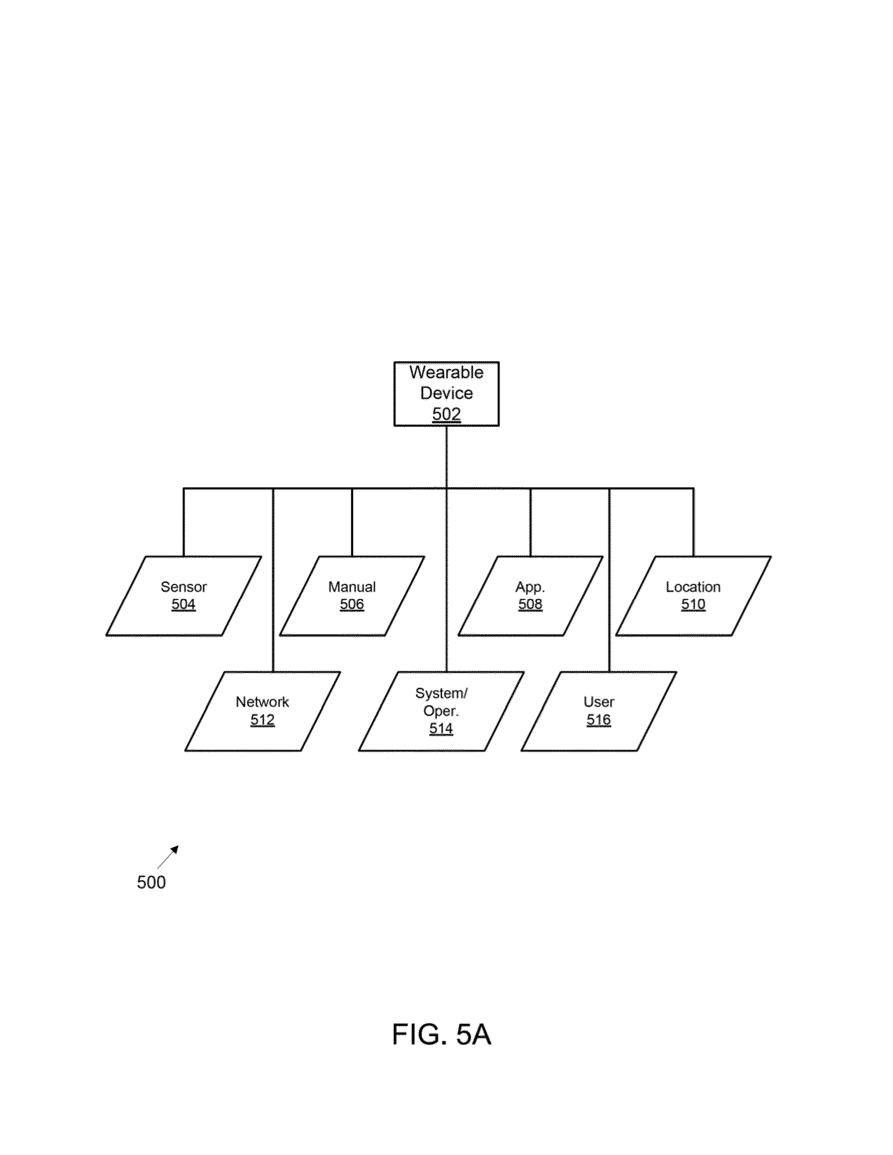

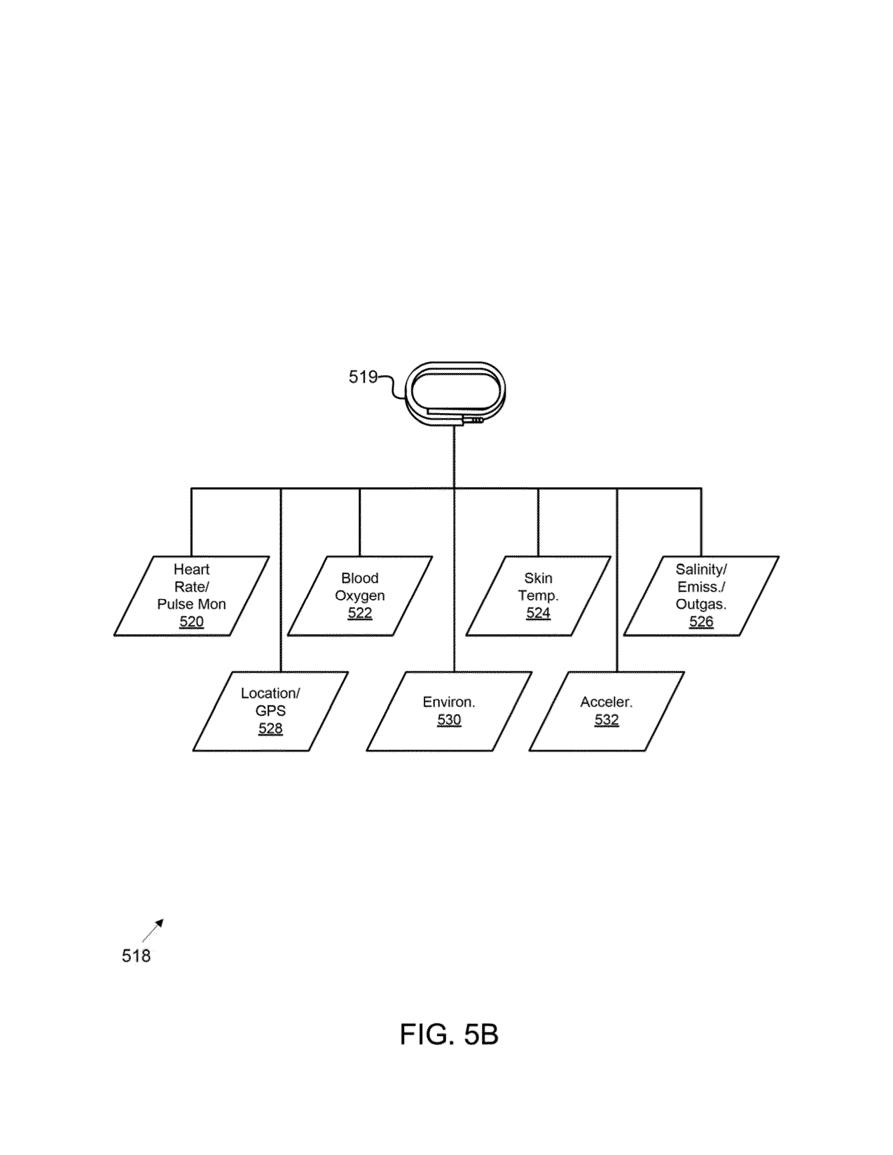

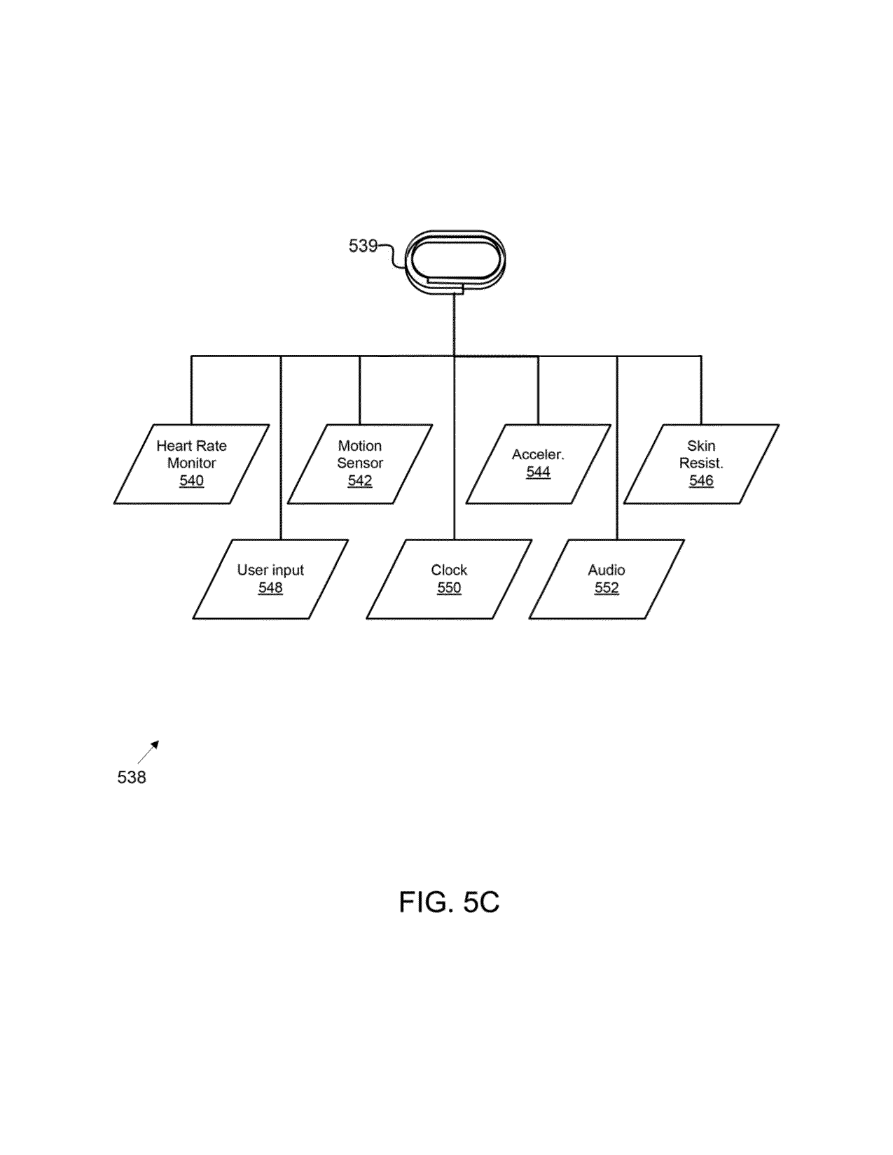

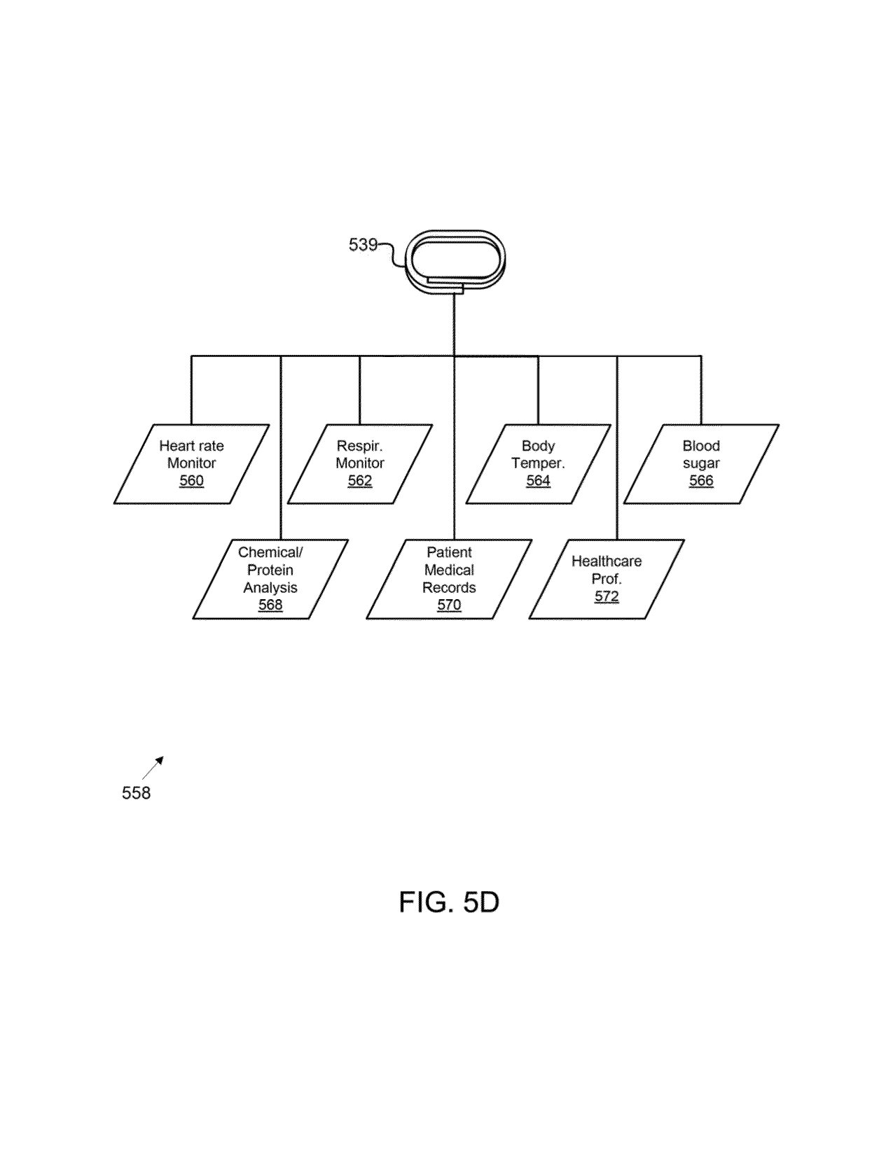

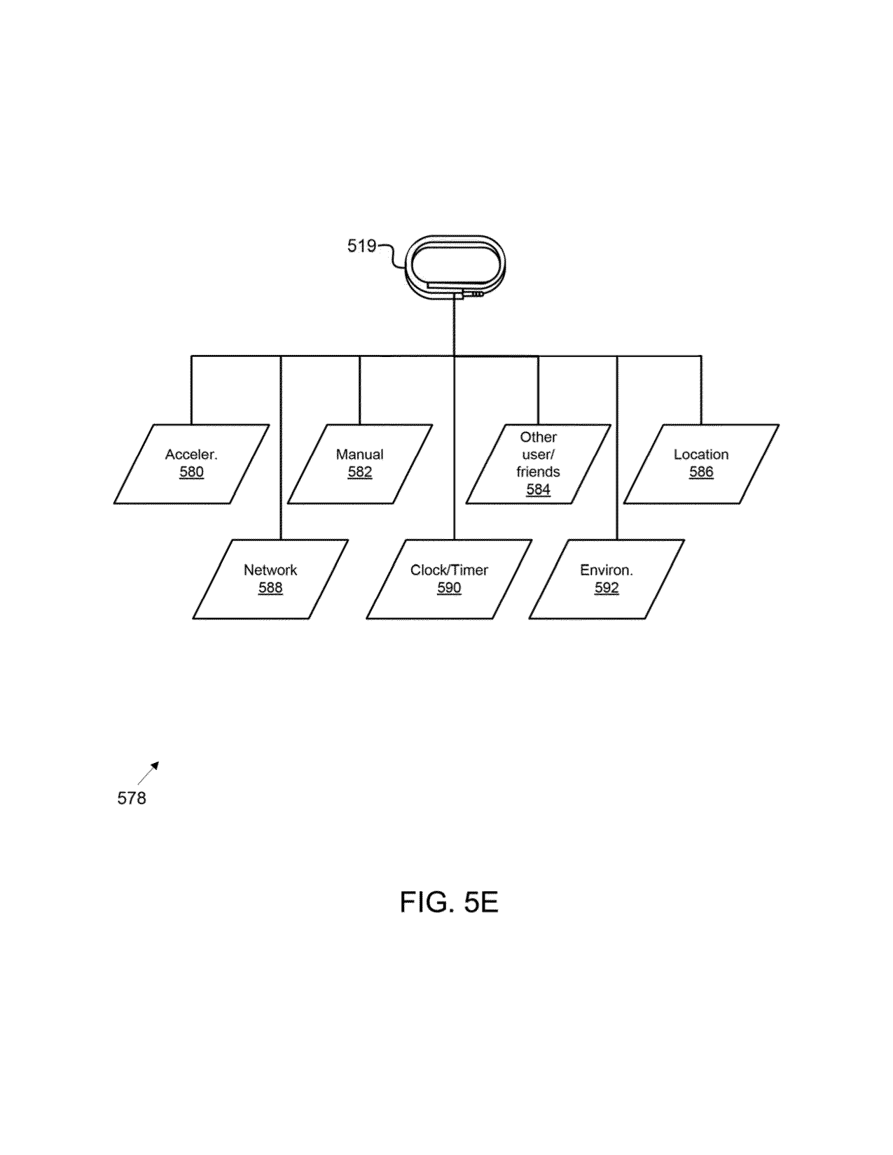

FIG. 5A illustrates representative data types for use with an exemplary data-capable strapband. Here, wearable device 502 may capture various types of data, including, but not limited to sensor data 504, manually-entered data 506, application data 508, location data 510, network data 512, system/operating data 514, and user data 516. Various types of data may be captured from sensors, such as those described above in connection with FIG. 3. Manually-entered data, in some examples, may be data or inputs received directly and locally by band 200 (FIG. 2). In other examples, manually-entered data may also be provided through a third-party website that stores the data in a database and may be synchronized from server 114 (FIG. 1) with one or more of bands 104-112. Other types of data that may be captured including application data 508 and system/operating data 514, which may be associated with firmware, software, or hardware installed or implemented on band 200. Further, location data 510 may be used by wearable device 502, as described above. User data 516, in some examples, may be data that include profile data, preferences, rules, or other information that has been previously entered by a given user of wearable device 502. Further, network data 512 may be data is captured by wearable device with regard to routing tables, data paths, network or access availability (e.g., wireless network access availability), and the like. Other types of data may be captured by wearable device 502 and are not limited to the examples shown and described. Additional context-specific examples of types of data captured by bands 104-112 (FIG. 1) are provided below.

FIG. 5B illustrates representative data types for use with an exemplary data-capable strapband in fitness-related activities. Here, band 519 may be configured to capture types (i.e., categories) of data such as heart rate/pulse monitoring data 520, blood oxygen saturation data 522, skin temperature data 524, salinity/emission/outgassing data 526, location/GPS data 528, environmental data 530, and accelerometer data 532. As an example, a runner may use or wear band 519 to obtain data associated with his physiological condition (i.e., heart rate/pulse monitoring data 520, skin temperature, salinity/emission/outgassing data 526, among others), athletic efficiency (i.e., blood oxygen level data 522), and performance (i.e., location/GPS data 528 (e.g., distance or laps run), environmental data 530 (e.g., ambient temperature, humidity, pressure, and the like), accelerometer 532 (e.g., biomechanical information, including gait, stride, stride length, among others)). Other or different types of data may be captured by band 519, but the above-described examples are illustrative of some types of data that may be captured by band 519. Further, data captured may be uploaded to a website or online/networked destination for storage and other uses. For example, fitness-related data may be used by applications that are downloaded from a “fitness marketplace” where athletes may find, purchase, or download applications for various uses. Some applications may be activity-specific and thus may be used to modify or alter the data capture capabilities of band 519 accordingly. For example, a fitness marketplace may be a website accessible by various types of mobile and non-mobile clients to locate applications for different exercise or fitness categories such as running, swimming, tennis, golf, baseball, football, fencing, and many others. When downloaded, a fitness marketplace may also be used with user-specific accounts to manage the retrieved applications as well as usage with band 519, or to use the data to provide services such as online personal coaching or targeted advertisements. More, fewer, or different types of data may be captured for fitness-related activities.

FIG. 5C illustrates representative data types for use with an exemplary data-capable strapband in sleep management activities. Here, band 539 may be used for sleep management purposes to track various types of data, including heart rate monitoring data 540, motion sensor data 542, accelerometer data 544, skin resistivity data 546, user input data 548, clock data 550, and audio data 552. In some examples, heart rate monitor data 540 may be captured to evaluate rest, waking, or various states of sleep. Motion sensor data 542 and accelerometer data 544 may be used to determine whether a user of band 539 is experiencing a restful or fitful sleep. For example, some motion sensor data 542 may be captured by a light sensor that measures ambient or differential light patterns in order to determine whether a user is sleeping on her front, side, or back. Accelerometer data 544 may also be captured to determine whether a user is experiencing gentle or violent disruptions when sleeping, such as those often found in afflictions of sleep apnea or other sleep disorders. Further, skin resistivity data 546 may be captured to determine whether a user is ill (e.g., running a temperature, sweating, experiencing chills, clammy skin, and others). Still further, user input data may include data input by a user as to how and whether band 539 should trigger vibration source 208 (FIG. 2) to wake a user at a given time or whether to use a series of increasing or decreasing vibrations to trigger a waking state. Clock data (550) may be used to measure the duration of sleep or a finite period of time in which a user is at rest. Audio data may also be captured to determine whether a user is snoring and, if so, the frequencies and amplitude therein may suggest physical conditions that a user may be interested in knowing (e.g., snoring, breathing interruptions, talking in one's sleep, and the like). More, fewer, or different types of data may be captured for sleep management-related activities.

FIG. 5D illustrates representative data types for use with an exemplary data-capable strapband in medical-related activities. Here, band 539 may also be configured for medical purposes and related-types of data such as heart rate monitoring data 560, respiratory monitoring data 562, body temperature data 564, blood sugar data 566, chemical protein/analysis data 568, patient medical records data 570, and healthcare professional (e.g., doctor, physician, registered nurse, physician's assistant, dentist, orthopedist, surgeon, and others) data 572. In some examples, data may be captured by band 539 directly from wear by a user. For example, band 539 may be able to sample and analyze sweat through a salinity or moisture detector to identify whether any particular chemicals, proteins, hormones, or other organic or inorganic compounds are present, which can be analyzed by band 539 or communicated to server 114 to perform further analysis. If sent to server 114, further analyses may be performed by a hospital or other medical facility using data captured by band 539. In other examples, more, fewer, or different types of data may be captured for medical-related activities.

FIG. 5E illustrates representative data types for use with an exemplary data-capable strapband in social media/networking-related activities. Examples of social media/networking-related activities include related to Internet-based Social Networking 15 Services (“SNS”), such as Facebook®, Twitter®, etc. Here, band 519, shown with an audio data plug, may be configured to capture data for use with various types of social media and networking-related services, websites, and activities. Accelerometer data 580, manual data 582, other user/friends data 584, location data 586, network data 588, clock/timer data 590, and environmental data 592 are examples of data that may be gathered and shared by, for example, uploading data from band 519 using, for example, an audio plug such as those described herein. As another example, accelerometer data 580 may be captured and shared with other users to share motion, activity, or other movement-oriented data. Manual data 582 may be data that a given user also wishes to share with other users. Likewise, other user/friends data 584 may be from other bands (not shown) that can be shared or aggregated with data captured by band 519. Location data 586 for band 519 may also be shared with other users. In other examples, a user may also enter manual data 582 to prevent other users or friends from receiving updated location data from band 519. Additionally, network data 588 and clock/timer data may be captured and shared with other users to indicate, for example, activities or events that a given user (i.e., wearing band 519) was engaged at certain locations. Further, if a user of band 519 has friends who are not geographically located in close or near proximity (e.g., the user of band 519 is located in San Francisco and her friend is located in Rome), environmental data can be captured by band 519 (e.g., weather, temperature, humidity, sunny or overcast (as interpreted from data captured by a light sensor and combined with captured data for humidity and temperature), among others). In other examples, more, fewer, or different types of data may be captured for medical-related activities.

FIG. 6 illustrates an exemplary recommendation system. Here, recommendation system 600 includes recommendation engine 602, user interface module (hereafter “UI module”) 604, logic 606, point module 608, application programming interface (hereafter “API”) 610, valuator 612, databases 614-616, network 618, and data types 620-634. In some examples, data types 620-634 may be of various types of data converted or transformed (i.e., “transformed”) from sensory input received by, for example, sensor 212 (FIG. 2B), including psychological data 620, physiological data 622, biological data 624, activity data 626, state data 628, mood data 630, sleep data 632, medical data 634, among others, without limitation. In some examples, data types 620-634 may be transformed from input received from a variety of sensors, including one or more of the sensors described in connection with FIG. 3. For example, input from an accelerometer (i.e., accelerometer 302), an HR monitor (i.e., HR monitor 308), an audio sensor (i.e., audio sensor 310), a location-based service sensor (i.e., location-based service sensor 318), and other sensors, may be transformed into sleep data 632. In another example, input from a chemical sensor (i.e., chemical sensor 324), an HR monitor (i.e., HR monitor 308), an IR sensor (i.e., IR sensor 306), and other sensors, may be transformed into mood data 630. In still other examples, input from different groups of sensors may be transformed into other data types. As shown recommendation engine 602 may be configured to receive data types 620-634 using UI module 604. In some examples, UI module 604 may be configured to provide various interfaces (e.g., a form, a field, a download/upload interface, a drag-and-drop interface, or the like) and to receive user input in a variety of formats, including typing (i.e., into a field), uploading data (e.g., from an external drive, a camera, a portable USB-drive, a CD-ROM, a DVD, a portable computing device, a smartphone, a portable communication device, a wearable device, or other device), a mouse click (i.e., in a form), another type of selection (i.e., using a drag-and-drop interface), or other formats. Logic 606 may be configured to perform various types of functions and operations using user and system-specified rules. For example, logic 606 may generate a control signal configured to initiate the transformation of sensory input received by sensor 212 into data configured to be sent to recommendation engine 602. In another example, logic 606 may be configured to generate different control signals according to different rules. For example, logic 606, which may be implemented separately or as a part of processor 204 (FIGS. 2A-2B) may indicate that valuator 612 should quantitatively calculate, algorithmically or otherwise, a value for the received data and assign a point value by point module 608. In some examples, an assigned point value may be used to compare an account associated with a wearable device (e.g., band 200 (FIG. 2A) or band 220 (FIG. 2B)) with another account (i.e., wearable device) or against a set of data or parameters specified by a user (e.g., a fitness, health, athletic, or wellness-oriented goal). For example, a database (e.g., database 614-616) may store information in, with, or otherwise associated with, an account (e.g., associated with a wearable device, band or user), the information including information (e.g., data, points, or other values) associated with, for example, a fitness goal, a health issue, a medical condition, an activity, a promotion, an award or award program, or the like. Point module 608 may also be configured to cooperatively process data in order to present to a user a display or other rendering that illustrates progress, status, or state. For example, point module 608 may be configured to present a “lifeline,” other graph or graphic, or other abstract representation of a given user's health, wellness, or other characteristic. Further, point module 608 may be generated by recommendation engine 602 in order to provide a user interface or other mechanism by which a user of a wearable device can view various types of qualitative and quantitative information associated with data provided from various types of sensors such as those described herein.

As shown, recommendation engine 602 may be configured to present content on or at a user interface using API 610. In some examples, content may be recommendations that are presented relative to data types evaluated by recommendation engine 602. In some examples, recommendations may be presented in various types of forms and formats such as vibration, noise, light, or other sensory notification. In other examples, recommendations also may be textual, graphical, visual, audible, or other types of content that may be perceived by a user of a wearable device. For example, if recommendation engine 602 detects, using mood data type 630, that a user is depressed (i.e., lowered heart rate or pulse, skin tautness is lessened, biological, physiological, psychological, or other factors indicate a depressed state), recommendation engine 602 may be configured to request content from database 614 (which may be in local data communication with recommendation engine 602) or database 616 (which may be remotely in data communication with recommendation engine 602 over network 618 (e.g., LAN, WAN, MAN, cloud, SAN, and others). Such content may be a recommendation, and may include a discounted promotion to a day spa, a vibration or, other sensory notification intended to stimulate a user to improve or heighten her mood (i.e., psychological state). In other examples, a recommendation, or other content generated by recommendation engine 602, may be related to an activity or state. In other examples, recommendation engine 602 may be used to generate other types of recommendations, including advertisements, promotions, awards, offers, editorial (e.g., newscasts, podcasts, video logs (i.e., vlogs), web logs (i.e., blogs), text, video, multimedia, or other types of content retrieved from database 614 and/or 616. In some examples, a recommendation generated by recommendation engine 602 may be associated with a health condition, medical condition, fitness goal, award, promotion, or the like. In still other examples, recommendation system 600 and the above-described elements may be varied and are not limited to those shown and described.

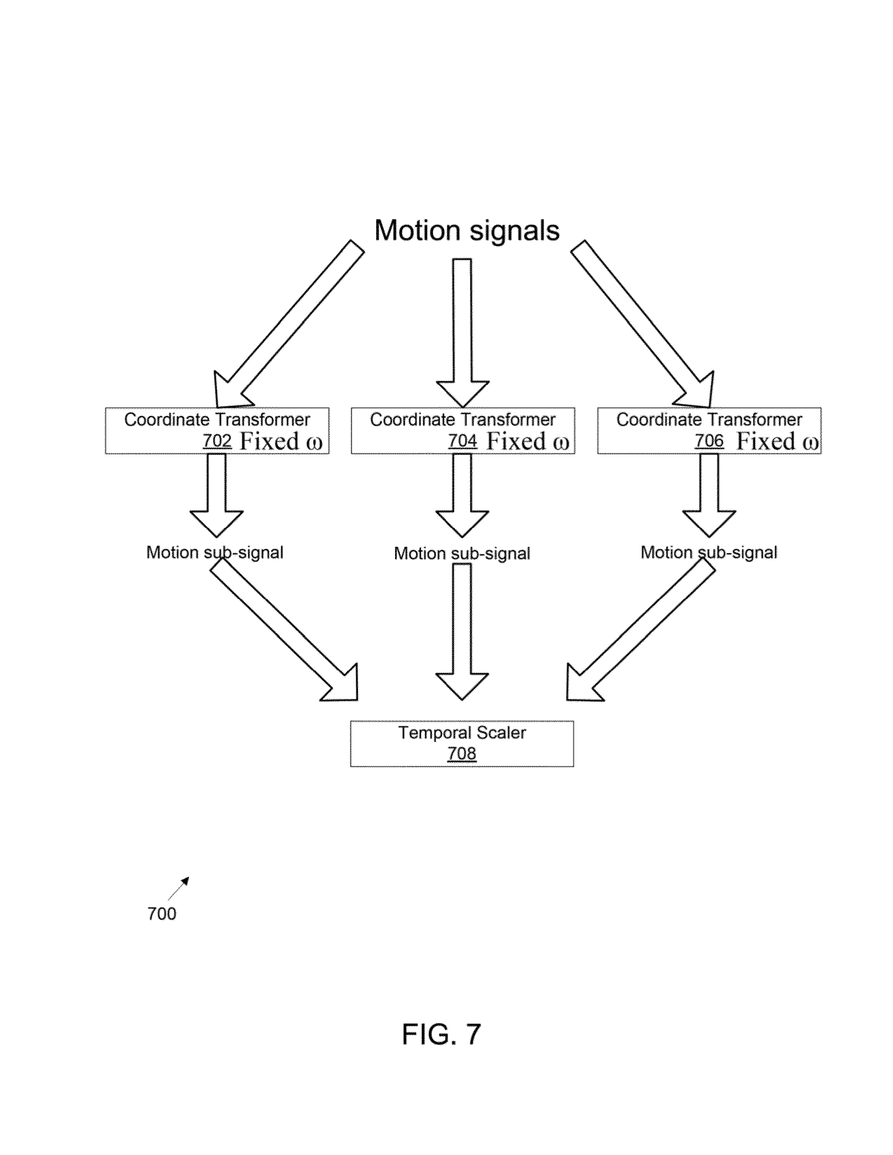

FIG. 7 illustrates an exemplary system for feature extraction from body-worn accelerometers. Here, system 700 includes coordinate transformers 702-706 and temporal scalar 708. In some examples, banks of coordinate transformers (e.g., coordinate transformers 702-706) may be implemented and are not limited to the quantity, type, or functions shown. Various types of motions associated with bodily limbs and appendages may be measured, at a fixed angular rate (i.e., fixed ω), using coordinate transformers 702-706. As shown, coordinate transformers 702-706 may be configured to receive motion signals that are algorithmically processed to identify one or more motion sub-signals. In some examples, each of coordinate transformers 702-706 may be associated with a particular angular rate. When introduced to temporal scalar 708, the rate of information production for lower angular rates may be reduced, which may lead to a near-constant critical distance, which in turn may be used to generate various types of vectors (e.g., temporal, spatial, and others) for purposes of determining motion calculations that may be used to identify various types of motion. Such vectors can provide both magnitude and directional components of motion for other algorithmic processing functions (e.g., vector analysis, Fourier transformations, and others) to determine various aspects associated with motion, such as velocity, speed, rate of change, axis, and others, and for analyses of data transformed or otherwise derived from sensory input to, for example, sensor 212 (FIG. 2A).

Using motion sub-signals and banks (i.e., logical groupings) of coordinate transformers, transformation processes or functions may be performed on input (i.e., motion signals that have been quantitatively reduced to vectors or other measurable quantities or types) in order to facilitate the production of data that may be used to process other functions associated with wearable devices such as band 200. As an example, a body may be evaluated as a linked set of rigid “beams” (i.e., limbs or other bodily parts, taking into account quantitative variables for moments and inertia) that are connected or coupled by rotational joints. By measuring the length of a “beams,” different angular rate dynamics can occur and may be determined, or otherwise processed, using system 700. Measurements of angular rate dynamics may allow for the extraction of data from body-worn accelerometers in an efficient manner resulting from a reduction in the use of space for electrical, electronic, and logic-based components for performing these calculations or otherwise manipulating motion signals. Further, system 700 may be used to reduce power consumption, memory accesses and operations, and the number of operations performed over a given length of time (e.g., MIPS).

In other examples, different techniques may be used to advantageously improve the processing capabilities of system 700 and, for example, band 200. For example, different sensors coupled to or in data communication with band 200 may monitor or sense the same or substantially similar sensory input. Generally, signals from different sensors (e.g., sensor 212 (FIG. 2A)) may illustrate some degree of correlation, but noise measurements may be uncorrelated. For example, an accelerometer may show noise resulting from the movement of a structure to which it is attached (e.g., a wearable device), but a microphone may show acoustic noise emanating from a given environment. By using one or multiple sensors in combination with the described techniques, it may be possible to reject noise and accentuate a signal generated from multiple domains (e.g., different sensors having different sample rates, frequency responses, ranges, or the like). In still other examples, system 700 and the above-described elements may be varied and are not limited to those provided.

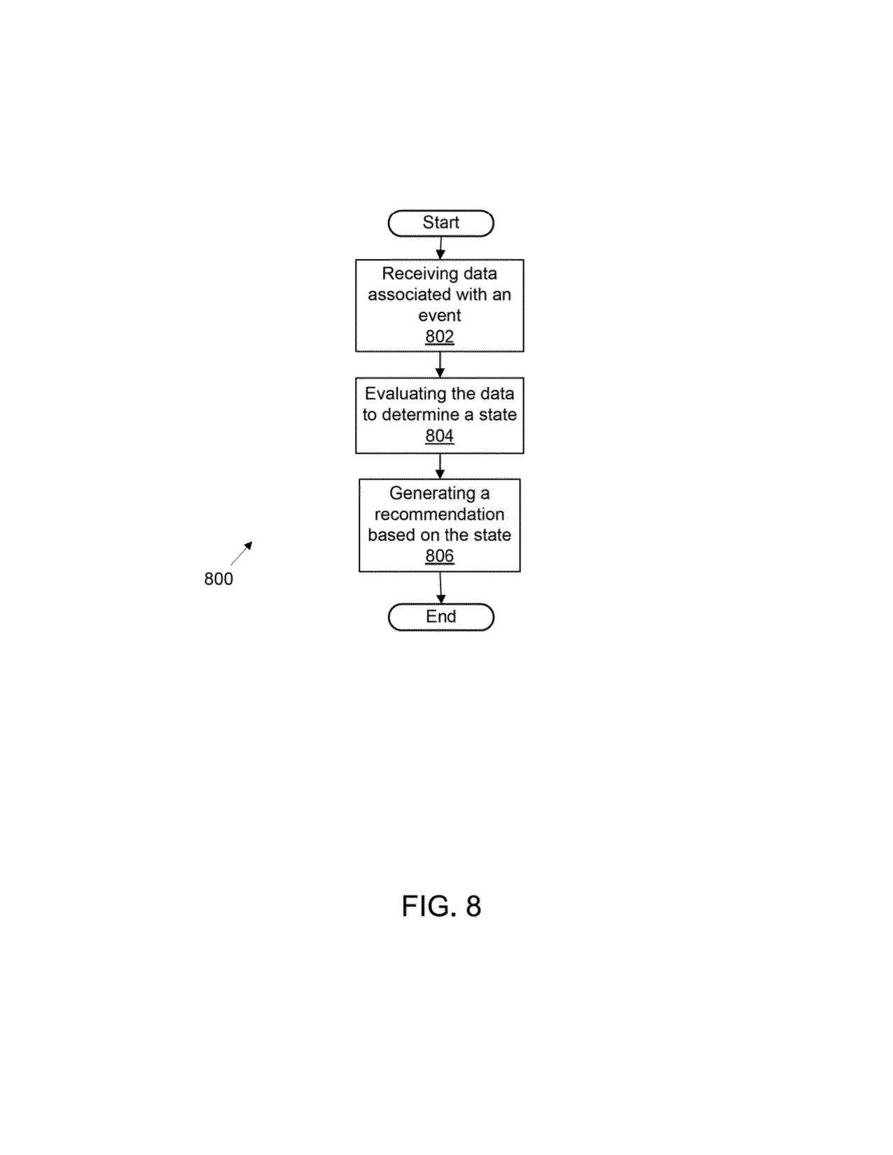

FIG. 8 illustrates an exemplary determinative process for wearable devices. Here, process 800 begins by receiving data associated with an event (802). In some examples, a wearable device (e.g., bands 104-112 (FIG. 1), wearable device 220 (FIG. 2B), and the like) may be configured to gather, or capture, the data associated with the event. In other examples, data may comprise, or otherwise be associated with, sensory input detected by a sensor, for example, coupled to a wearable device. In some examples, an event may be a part of, or otherwise associated with, an activity (e.g., running, walking, sleeping, working, swimming, cycling, or the like). In other examples, an event may be a part of, or otherwise associated with, a biological state, a physiological state, a psychological state, or the like. Once received, data may be evaluated to determine a state associated with a user of a wearable device (804). In some examples, data may be received and evaluated using a recommendation engine (e.g., recommendation engine 602). In other examples, data may be received and evaluated using a different engine or unit in communication with a recommendation engine. In some examples, a state may be determinative of a user's mood, emotional or physical state or status, biological condition, medical condition, athletic form, or the like. In some examples, evaluating data may include determining various types of information using the data. For example, data may be used to determine a type of activity associated with an event, a level of activity associated with an event, a value associated with an event, or other information. Once evaluated, data may then be used to generate a recommendation, as described above in connection with FIGS. 2A and 6 (806). In some examples, a recommendation may be generated by a recommendation engine (e.g., recommendation engine 602) implemented on a wearable device. In other examples, a recommendation engine (e.g., recommendation engine 602) for generating a recommendation may be implemented on another device in data communication with a wearable device. In some examples, a state that is determined also may be compared to one or more other states (i.e., stored in a memory or database accessible by a recommendation engine) to identify another recommendation associated with the event. In some examples, a wearable device may include a user interface configured to display graphics, or otherwise provide notifications or prompts (e.g., through sounds, vibrations, or other sensory communication methods), associated with a recommendation. In other examples, the above-described process may be varied in function, order, process, implementation, or other aspects and is not limited to those provided.

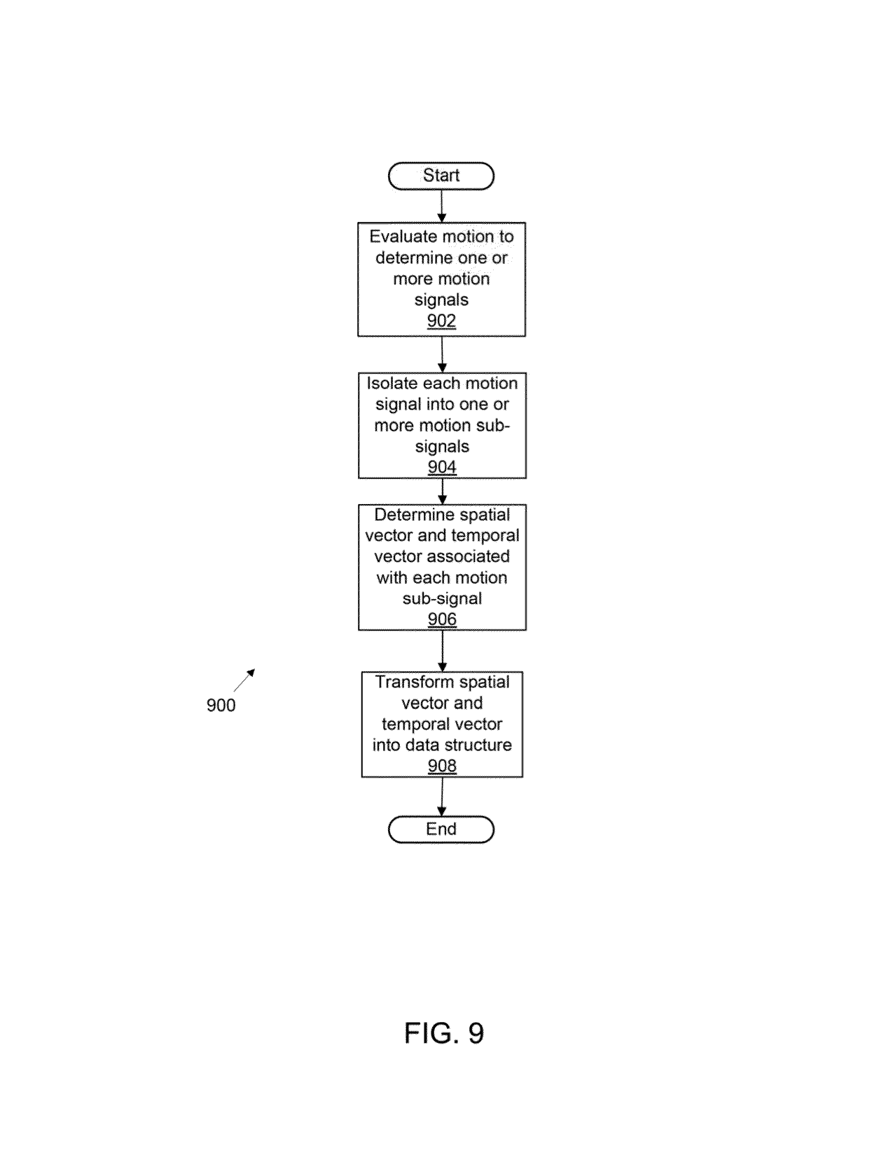

FIG. 9 illustrates another exemplary determinative process for wearable devices. Here, a motion may be evaluated to determine one or more motion signals (902). In some examples, motion and motion signals may be associated with movement of a limb or appendage. In some examples, motion may be detected by a sensor on a wearable device, and the wearable device may include circuitry configured to generate one or more motion signals. Once determined, motion signals may be further isolated into motion sub-signals (904) that, when evaluated may be used to determine spatial and temporal vectors associated with each motion sub-signal (906). In some examples, motions signals may be isolated into motion sub-signals using one or more coordinate transformers (e.g., coordinate transformers 702-706). In some examples, a motion signal may be processed according to one or more algorithms configured to identify one or more motion sub-signals. Using spatial and temporal vectors associated with each motion sub-signal, a data structure (or set of data structures) may be generated that may be used, for example, to develop a model or pattern associated with an activity or a state, from which recommendations or other content, indicators, or information, such as those described herein, may be generated (908). In some examples, data structure may be generated using vectors, or other data, output from a temporal scalar (e.g., temporal scalar 708), which may be configured to process motion signals or sub-signals to generate various types of vectors that may be used to identify and determine motion or types thereof. In other examples, process 900 may be varied in function, order, process, implementation, or other aspects and is not limited to those provided.

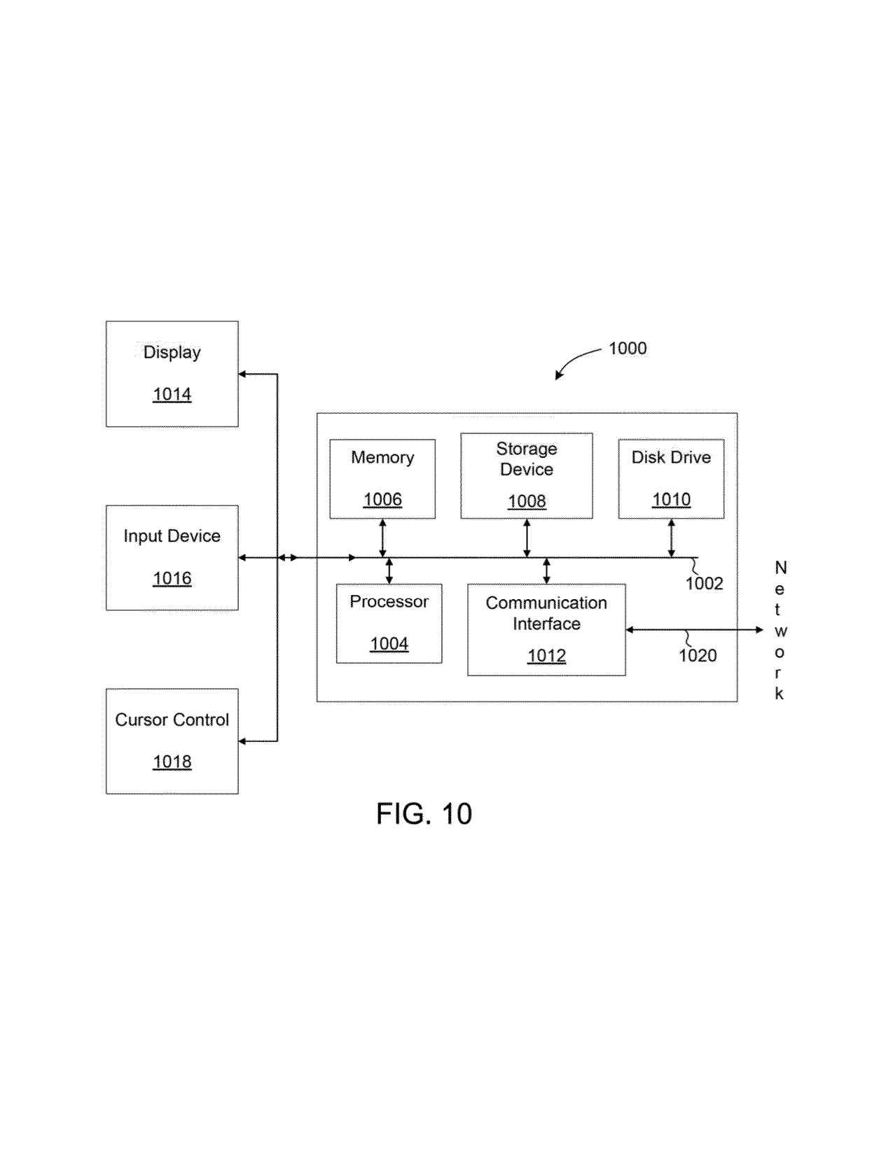

FIG. 10 illustrates an exemplary computer system suitable for use with determinative processes for wearable devices. In some examples, computer system 1000 may be used to implement computer programs, applications, methods, processes, or other software to perform the above-described techniques. Computer system 1000 includes a bus 1002 or other communication mechanism for communicating information, which interconnects subsystems and devices, such as processor 1004, system memory 1006 (e.g., RAM), storage device 1008 (e.g., ROM), disk drive 1010 (e.g., magnetic or optical), communication interface 1012 (e.g., modem or Ethernet card), display 1014 (e.g., CRT, LCD, LED, OLED, eInk, or reflective), input device 1016 (e.g., keyboard), and cursor control 1018 (e.g., mouse or trackball).

According to some examples, computer system 1000 performs specific operations by processor 1004 executing one or more sequences of one or more instructions stored in system memory 1006. Such instructions may be read into system memory 1006 from another computer readable medium, such as static storage device 1008 or disk drive 1010. In some examples, hard-wired circuitry may be used in place of or in combination with software instructions for implementation.

The term “computer readable medium” refers to any tangible medium that participates in providing instructions to processor 1004 for execution. Such a medium may take many forms, including but not limited to, non-volatile media and volatile media. Non-volatile media includes, for example, optical or magnetic disks, such as disk drive 1010. Volatile media includes dynamic memory, such as system memory 1006.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1002 for transmitting a computer data signal.

In some examples, execution of the sequences of instructions may be performed by a single computer system 1000. According to some examples, two or more computer systems 1000 coupled by communication link 1020 (e.g., LAN, PSTN, or wireless network) may perform the sequence of instructions in coordination with one another. Computer system 1000 may transmit and receive messages, data, and instructions, including program, i.e., application code, through communication link 1020 and communication interface 1012. Received program code may be executed by processor 1004 as it is received, and/or stored in disk drive 1010, or other non-volatile storage for later execution.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
evaluating a motion to determine one or more motion signals, the motion being evaluated using data provided by one or more sensors in data communication with a wearable device;
isolating each of the one or more motion signals into one or more motion sub-signals;
determining a spatial vector and a temporal vector associated with each of the one or more motion sub-signals; and
transforming the spatial vector and the temporal vector into a data structure to be used by an application configured to analyze the data structure and to generate content associated with the motion.

2. The method of claim 1, wherein each of the one or more motion signals is isolated at an angular rate.

3. The method of claim 2, wherein each of the one or more motion signals is isolated using a coordinate transformer.

4. The method of claim 1, wherein isolating each of the one or more motion signals comprises processing the one or more motion signals using a bank of coordinate transformers, each of the coordinate transformers associated with a fixed angular rate.

5. The method of claim 1, wherein the application is configured to analyze the data structure using an algorithm configured to determine a magnitude component of the motion.

6. The method of claim 1, wherein the application is configured to analyze the data structure using an algorithm configured to determine a directional component of the motion.

7. The method of claim 1, wherein the application is configured to analyze the data structure using an algorithm configured to determine a velocity of the motion.

8. The method of claim 1, wherein the application is configured to analyze the data structure using an algorithm configured to determine a speed of the motion.

9. The method of claim 1, wherein the application is configured to analyze the data structure using an algorithm configured to determine a rate of change of the motion.

10. The method of claim 1, wherein the application is configured to analyze the data structure using an algorithm configured to determine an axis of the motion.

11. The method of claim 1, wherein the one or more sensors includes an accelerometer.

12. The method of claim 1, wherein the one or more sensors includes an audio sensor.

13. The method of claim 1, wherein the one or more sensors are configured to capture the data from the motion in a body part during an activity, the wearable device being configured to be worn on the body part.

14. The method of claim 1, wherein the motion is associated with movement of a body part.

15. A system, comprising:
a database configured to store data provided by one or more sensors in data communication with a wearable device; and
a logic module configured to evaluate a motion to determine on or more motion signals, the motion being evaluated using the data provided by the one or more sensors in data communication with the wearable device, to isolate each of the one or more motion signals into one or more motion sub-signals, to determine a spatial vector and a temporal vector associated with each of the one or more motion sub-signals, and to transform the spatial vector and the temporal vector into a data structure to be used by an application configured to analyze the data structure and to generate content associated with the motion.

16. The system of claim 15, further comprising circuitry being configured to generate the one or more motion signals.

17. The system of claim 15, further comprising one or more coordinate transformers, each of the one or more coordinate transformers being configured to isolate a motion signal into a motion sub-signal.

18. The system of claim 15, further comprising a temporal scalar being configured to filter a motion sub-signal.

19. A computer program product embodied in a computer readable medium and comprising computer instructions for:
evaluating a motion to determine one or more motion signals, the motion being evaluated using data provided by one or more sensors in data communication with a wearable device;
isolating each of the one or more motion signals into one or more motion sub-signals;
determining a spatial vector and a temporal vector associated with each of the one or more motion sub-signals; and
transforming the spatial vector and the temporal vector into a data structure to be used by an application configured to analyze the data structure and to generate content associated with the motion.
